(19) United States
(12) Patent Application Publication
(10) Pub. No.: US 2014/0284912 A1
(43) Pub. Date: Sep. 25, 2014

(54) ANTI-COUNTERFEIT PRINTED MATTER

(71) Applicants: Hiroyuki Oshima, Tokyo (JP); Yukio Akiyama, Funabashi (JP); Naomi Udagawa, Tokyo (JP)

(72) Inventors: Hiroyuki Oshima, Tokyo (JP); Yukio Akiyama, Funabashi (JP); Naomi Udagawa, Tokyo (JP)

(73) Assignee: NATIONAL PRINTING BUREAU, INCORPORATED ADMINISTRATIVE AGENCY, Tokyo (JP)

(21) Appl. No.: 14/350,734

(22) PCT Filed: Aug. 29, 2012
(86) PCT No.: PCT/JP2012/071892

§ 371 Date: Jun. 10, 2014

(30) Foreign Application Priority Data
Oct. 11, 2011 (JP) 2011-223869
Oct. 11, 2011 (JP) 2011-223870

(51) Int. Cl. B42D 15/00; B42D 25/00

(52) U.S. Cl. CPC B42D 15/0013; B42D 15/10
USPC 283/85

(57) ABSTRACT

This invention relates to a printed matter which visualizes a latent image pattern by periodically formed raised image lines when observed in a tilted state, and provides an anti-counterfeit printed matter which allows latent images having different densities to be observed from a plurality of observation angles.

In the anti-counterfeit printed matter, a region serving as a shade of a latent image is formed in addition to image lines forming a latent image portion and those forming a background portion, or at least one of the latent image portion, the background portion, and the shade portion is divided into a plurality of regions, and image lines formed in the divided regions are arranged at different angles, thereby forming a three-dimensional latent image observed from a plurality of directions.

### TECHNICAL FIELD

The present invention relates to an anti-counterfeit printed matter in which the image lines of a latent image intaglio to be used to prevent counterfeiting and duplication are formed on a banknote, passport, securities, gift certificate, various kinds of certificates, or the like, the image lines of the latent image intaglio are arranged at an arrangement angle that changes between a plurality of regions so as to enhance the latent image, and a three-dimensional latent image is observed.

### BACKGROUND ART

Conventionally, anti-counterfeit printed matters such as banknotes, passports, gift certificates, and various kinds of certificates are required to be given an anti-counterfeit technique, and various techniques have been disclosed regarding these printed matters. Representative examples are watermark and thread that give an anti-counterfeit technique in a manufacturing process of paper serving as a base, microletters and pearl printing that give an anti-counterfeit technique in a printing process, and a hologram and laser perforation that give an anti-counterfeit technique in another process after a printing process.

Out of these techniques, a latent image intaglio is a relatively inexpensive anti-counterfeit technique with a high resistance to counterfeiting. This is because many counterfeiters often make counterfeits using a simple output apparatus such as a printer and therefore can make only counterfeits having a two-dimensional structure with a low ink profile. On the other hand, a latent image intaglio forms a latent image by periodically arranging raised image lines in the vertical and horizontal directions. This attains a three-dimensional arrangement which generates a density difference between vertical image lines and horizontal image lines due to compression and non-compression of the raised image lines observed from a specific direction so that the observer can visually recognize a latent image. A counterfeit made by a printer, however, cannot form raised image lines, as described above. Copying an authentic article alone cannot form a latent image. It is therefore difficult to do counterfeiting.

The arrangement of a printed matter P′ having a known latent image intaglio 1′ will be described first with reference to the accompanying drawings. FIG. 30 shows the arrangement of the printed matter P′ of the latent image intaglio 1′ formed by intaglio printing. The latent image intaglio 1′ is formed on a base such as paper. The printed matter P′ includes a latent image portion A′ and a background portion C′, as shown in FIG. 31. A plurality of horizontal image lines aL′ of the latent image portion A′ and a plurality of vertical image lines a′ of the background portion C′ are periodically arranged and formed from raised image lines. An image line width aW′ of the horizontal image line aL′ of the latent image portion A′ and an image line width cW′ of the vertical image line cL′ of the background portion C′ are equal. An image line pitch aP′ of the horizontal image lines aL′ and an image line pitch cP′ of the vertical image lines are also equal. Note that FIG. 31 is an enlarged view of a rectangular portion shown in FIG. 30.

The latent image of the printed matter P′ will be described next with reference to FIGS. 32 and 33. FIG. 32 shows observation directions of the printed matter P′. An observation direction U′ indicates an observation direction when visually recognizing the latent image intaglio 1′ from immediately above. On the other hand, an observation direction N′ indicates an observation direction when visually obliquely recognizing the latent image intaglio 1′. At this time, the latent image “T” cannot be observed in the observation direction U′ because the line area ratio per unit area of the latent image portion A′ equals that of the background portion C′.

A case in which the printed matter is visually recognized from the observation direction N′ will be described next. When the latent image intaglio 1′ is visually recognized from first observation directions (observation directions S1′ and S2′ (Y-axis directions)) shown in FIG. 30, the horizontal image lines aL′ of the latent image portion A′ are perpendicular to the observation directions, and the raised horizontal image lines aL′ partially or wholly occlude the non-image line portion, thereby increasing the apparent visual density, as shown in FIG. 33(a). On the other hand, the vertical image lines cL′ of the background portion C′ are parallel to the observation directions, and the density of the non-image line portion does not change. As a result, a density difference is generated between the latent image portion A′ and the background portion C′, and the latent image “T” formed from the latent image portion A′ can visually be recognized.

On the other hand, when the latent image intaglio 1′ is visually recognized from second observation directions (observation directions S3′ and S4′ (X-axis directions)) shown in FIG. 30, the image line arrangements are reverse to those in the first observation directions. Hence, as shown in FIG. 33(b), a latent image having a visual density reverse to that in FIG. 33(a) can visually be recognized.

FIG. 33(c) is a view showing the latent image intaglio 1′ visually recognized from third observation directions (observation directions S5′ and S6′ (diagonal directions)) shown in FIG. 30. FIG. 33(d) is a view showing the latent image intaglio 1′ visually recognized from fourth observation directions (observation directions S7′ and S8′ (other diagonal directions)) shown in FIG. 30. At this time, the latent image “T” cannot be visually recognized in the third and fourth observation directions. This is because even when visually recognized from a diagonal direction, the horizontal image lines aL′ and the vertical image lines cL′ have the same angle with respect to the observation direction, and no density difference is generated between the latent image portion A′ and the background portion C′. Note that FIG. 33 illustrates states in which observation is done from one direction concerning the first to fourth observation directions. When observed from the other direction, the orientations of the latent image and the background image are inverted, but the visual density does not change.

As described above, there have been disclosed various latent image intaglio techniques (for example, see patent literature 1).

As another form of a latent image intaglio, there has been disclosed a technique that allows a plurality of latent images to be visually recognized by providing oblique image lines in addition to vertical and horizontal image lines (for example, see patent literature 2).

### CITATION LIST

### Patent Literatures

Patent literature 1: Japanese Patent Publication No. 56-19273
Patent literature 2: Japanese Patent Laid-Open No. 2005-335153

### DISCLOSURE OF INVENTION

In the technique of patent literature 1, when visually recognized from a predetermined observation direction, the latent image can visually be recognized due to the density difference between the latent image portion A′ and the background portion C′. However, this is an authenticity determination method using only a simple density difference, and a more advanced authenticity determination method is demanded. Authenticity determination by the density difference between the latent image and the background image can also be regarded as authenticity determination by only a “binary image” having two different visual densities or authenticity determination by only a simple “plane image” by a density difference. Hence, an advanced authenticity determination method for an “image as well as or more than a binary image” or an “image as well as or more than a plane image” is demanded.

In addition, as described with reference to FIGS. 33(c) and 33(d), the latent image cannot be visually recognized depending on the observation direction. Furthermore, the latent image intaglio of patent literature 1 has a simple periodical image line arrangement in the vertical and horizontal directions. This arrangement can easily be duplicated with knowledge to some extent, and the resistance to counterfeiting is low.

A printed matter having the latent image intaglio of the patent literature 2 allows a plurality of latent images to be visually recognized by including vertical image lines, horizontal image lines, and oblique image lines. However, the line area ratio per unit area increases, and a visible image becomes dark. Additionally, since the line area ratio per unit area unbalances, the density of a visible image is uneven, resulting in many constraints on design. Furthermore, since the image line arrangement is not periodical, the visibility of the latent images is poor. “Visible image” of the present invention means an image visually recognized when observing a latent image intaglio from the observation direction U′.

The present invention has been made to solve the above-described problems, and has as its object to provide an anti-counterfeit printed matter that enables advanced authenticity determination by improving the visibility of a latent image.

An anti-counterfeit printed matter according to the present invention, in which a latent image portion including a first plane and a second plane, which are adjacent to each other, and a background portion are formed on a base, raised image lines being arranged at an equal pitch and an equal image line width in the latent image portion and the background portion, is characterized in that

the first plane has a region in which the image lines are arrayed along a first direction,

the second plane has a region in which the image lines are arrayed along a second direction different from the first direction,

the background portion has a region in which the image lines are arrayed along a third direction different from the first direction and the second direction,

when the printed matter is observed from immediately above, the first plane, the second plane, and the background portion are observed as a visible image having a uniform image line density, and

when the printed matter is observed while being tilted by a predetermined angle, the first plane, the second plane, and the background portion attain different visual densities, and the latent image portion is three-dimensionally observed.

Further, an anti-counterfeit printed matter according to the present invention, the first direction, the second direction, and the third direction is different from each other by not less than 20°.

Further, an anti-counterfeit printed matter according to the present invention, when one direction selected from the first direction, the second direction, and the third direction is set to 0°, one of the remaining directions may be set to 35° to 45°, and the other direction is set to 70° to 90°.

Further, an anti-counterfeit printed matter according to the present invention is characterized in that at least one of the first plane, the second plane, and the background portion is divided into a plurality of regions, and the image lines formed in the plurality of regions are arranged at different angles.

Further, an anti-counterfeit printed matter according to the present invention, including, on a base, a latent image portion and a background portion in which raised image lines are arranged at an equal pitch and an equal image line width, the image lines formed in the latent image portion and the background portion being arrayed in different directions so as to form a latent image, is characterized in that

the latent image portion and/or the background portion is divided into a plurality of regions,

when only the latent image portion is divided, the image lines are arrayed in different directions in the respective divided regions,

when only the background portion is divided, the image lines are arrayed in different directions in the respective divided regions,

when both the latent image portion and the background portion are divided, the image lines are arrayed in different directions in the respective divided regions,

when the printed matter is observed from immediately above, the latent image portion and the background portion are observed as a visible image having a uniform image line density, and

when the printed matter is observed while being tilted by a predetermined angle, the latent image portion and/or the background portion is observed while having different densities in the divided regions of the background portion.

Further, an anti-counterfeit printed matter according to the present invention is characterized in that the plurality of divided regions of the latent image portion and/or the background portion comprise at least three regions.

Further, an anti-counterfeit printed matter according to the present invention is characterized in that an angle of the direction of the image lines formed in the divided regions of the latent image portion and/or the background portion sequentially changes by an equal angle.

Further, an anti-counterfeit printed matter according to the present invention is characterized in that the angles of the direction of the image lines formed in the latent image portion and the background portion are different from each other by not less than 20°.

Further, an anti-counterfeit printed matter according to the present invention is characterized in that the direction of the image lines arrayed in at least one of the plurality of divided regions of the latent image portion and the direction of the image lines arrayed in at least one of the plurality of divided regions of the background portion have a relative angle difference of not less than 50°.

Further, an anti-counterfeit printed matter according to the present invention is characterized in that

the angle of the direction of the image lines formed in each of the plurality of regions of the latent image portion is not more than 45°, and

the angle of the direction of the image lines formed in each of the plurality of regions of the background portion is not more than 45°.

Further, an anti-counterfeit printed matter according to the present invention is characterized in that a camouflage image is formed by arranging the image lines while changing an area ratio per unit length of at least some of the image lines formed in the latent image portion and/or the background portion.

Further, an anti-counterfeit printed matter according to the present invention is characterized in that an image line width of the image lines is set to 0.05 to 0.3 mm.

Further, an anti-counterfeit printed matter according to the present invention is characterized in that an image line pitch of the image lines is set to 0.1 to 0.6 mm.

Further, an anti-counterfeit printed matter according to the present invention is characterized in that an image line height of the image lines is set to 0.02 to 0.10 mm.

Further, an anti-counterfeit printed matter according to the present invention is characterized in that the base has a whitish color, and the image lines are formed by blackish ink.

### Effects of the Invention

A printed matter including a first plane and a second plane in a latent image portion, which is an anti-counterfeit printed matter of the present invention, is not formed from only a latent image portion (only first plane) and a background portion, unlike the arrangement of a conventional latent image intaglio. Instead, the latent image portion is formed from a first plane and a second plane, and the angle of image lines is changed between the regions including the background portion. This makes it possible to enhance the latent image by the second plane when visually recognized from a predetermined observation direction, and also visually recognize the latent image as a three-dimensional image. In the conventional latent image intaglio, authenticity determination is done using a “plane image” as a latent image. In the present invention, however, authenticity determination can be done using a “three-dimensional image” including a shade image formed from the second plane in addition to a latent image formed from the first plane. Hence, advanced authenticity determination can be performed.

When visually recognized from predetermined observation directions, different latent images can visually be recognized in the respective observation directions. This improves the authenticity determination properties.

Additionally, as the anti-counterfeit printed matter of the present invention, a printed matter formed by dividing a latent image portion and/or a background portion into a plurality of regions and arranging the divided regions at different image line angles generates a gradation in the latent image and the like, and an a latent image with depth can visually be recognized when visually recognized from a predetermined observation direction. It is therefore possible to further improve the visibility of the latent image and perform advanced authenticity determination.

Furthermore, when visually recognized from a predetermined observation direction, a latent image having a different gradation density can visually be recognized in each observation direction. Hence, the authenticity determination properties improve. Note that in the same arrangement, when the region of the background portion is divided, and the image line angle is changed, the same effect as described above can be obtained. When the arrangement of the latent image portion and that of the background portion are combined, two types of gradations can be provided. A conventional latent image intaglio enables authenticity determination by a “binary image”. In the present invention, however, since authenticity determination can be performed by a “multivalued image” having three or more different visual densities, more advanced authenticity determination can be performed. Note that “gradation” in the present invention means enabling visual recognition by at least two or preferably three or more density differences in the region of the latent image portion or the background portion.

The latent image portion and/or the background portion can visually be recognized by a gradation. However, the raised image line that is a constituent element can be implemented by a general blackish ink material without using a special or expensive ink material. It is therefore possible to provide an inexpensive and effective anti-counterfeit printed matter.

In the anti-counterfeit printed matter according to the present invention, since the latent image portion and the background portion are formed from periodical image lines, the line area ratio per unit area does not change between the regions. For this reason, the image density of a visible image does not darken, and the same visual density as in a conventional visible image can be maintained. Hence, the degree of freedom in design is high.

The anti-counterfeit printed matter according to the present invention is formed by changing the image line angle in the respective divided regions of the latent image portion and/or the background portion. Since the image line arrangement is complex, the anti-counterfeit properties improve. In addition, this technique has a huge potential for development and high degree of freedom because various forms can be proposed as in Tables 1 to 4 described later.

### BRIEF DESCRIPTION OF THE DRAWINGS

FIG. 1 shows views illustrating the concept of a printed matter of the present invention;

FIG. 2 is a view showing observation directions of a printed matter of the present invention;

FIG. 3 is a sectional view showing a section of the printed matter of the present invention;

FIG. 4 is a view showing an example of a printed matter according to the first embodiment;

FIG. 5 is a view showing an example of the image line arrangement of a latent image intaglio according to the first embodiment;

FIG. 6 shows views illustrating examples of region division of a latent image portion or a background portion according to the first embodiment;

FIG. 7 is a view showing the arrangement of the printed matter in the main observation direction according to the first embodiment;

FIG. 8 is a view showing an example of a printed matter according to the second embodiment;

FIG. 9 is a view showing an example of the image line arrangement of a latent image intaglio according to the second embodiment;

FIG. 10 shows views illustrating examples of a shade portion of the latent image intaglio according to the second embodiment;

FIG. 11 is a view showing the arrangement of the printed matter in the main observation direction according to the second embodiment;

FIG. 12 shows views illustrating the printed matter according to the first embodiment visually recognized from predetermined observation directions;

FIG. 13 is a view showing a printed matter of Example 2;

FIG. 14 is a view showing a printed matter of Example 3;

FIG. 15 shows views illustrating the printed matter of Example 3 visually recognized from predetermined observation directions;

FIG. 16 is a view showing a printed matter of Example 4;

FIG. 17 is a view showing a printed matter of Example 5;

FIG. 18 shows views illustrating the printed matter of Example 5 visually recognized from predetermined observation directions;

FIG. 19 is a view showing a printed matter of Example 6;

FIG. 20 shows views illustrating the printed matter according to the second embodiment visually recognized from predetermined observation directions;

FIG. 21 is a view showing a printed matter of Example 8;

FIG. 22 is a view showing a printed matter of Example 9;

FIG. 23 is a view showing a printed matter of Example 10;

FIG. 24 is a view showing a printed matter of Example 11;

FIG. 25 shows views illustrating the printed matter of Example 11 visually recognized from predetermined observation directions;

FIG. 26 is a view showing a printed matter of Example 12;

FIG. 27 is a view showing a printed matter of Example 13;

FIG. 28 is a view showing a printed matter of Example 14;

FIG. 29 shows views illustrating the printed matter of Example 14 visually recognized from predetermined observation directions;

FIG. 30 is a view showing an example of a conventional printed matter;

FIG. 31 is a view showing an example of the image line arrangement of a conventional latent image intaglio;

FIG. 32 is a view showing observation directions of the conventional printed matter; and

FIG. 33 shows views illustrating the conventional printed matter visually recognized from predetermined observation directions.

### BEST MODE FOR CARRYING OUT THE INVENTION

Embodiments of the invention will now be described with reference to the accompanying drawings. However, the present invention is not limited to the embodiments to be described below and also incorporates various other embodiments within the technical scope defined in the appended claims.

### (Concept of Present Invention)

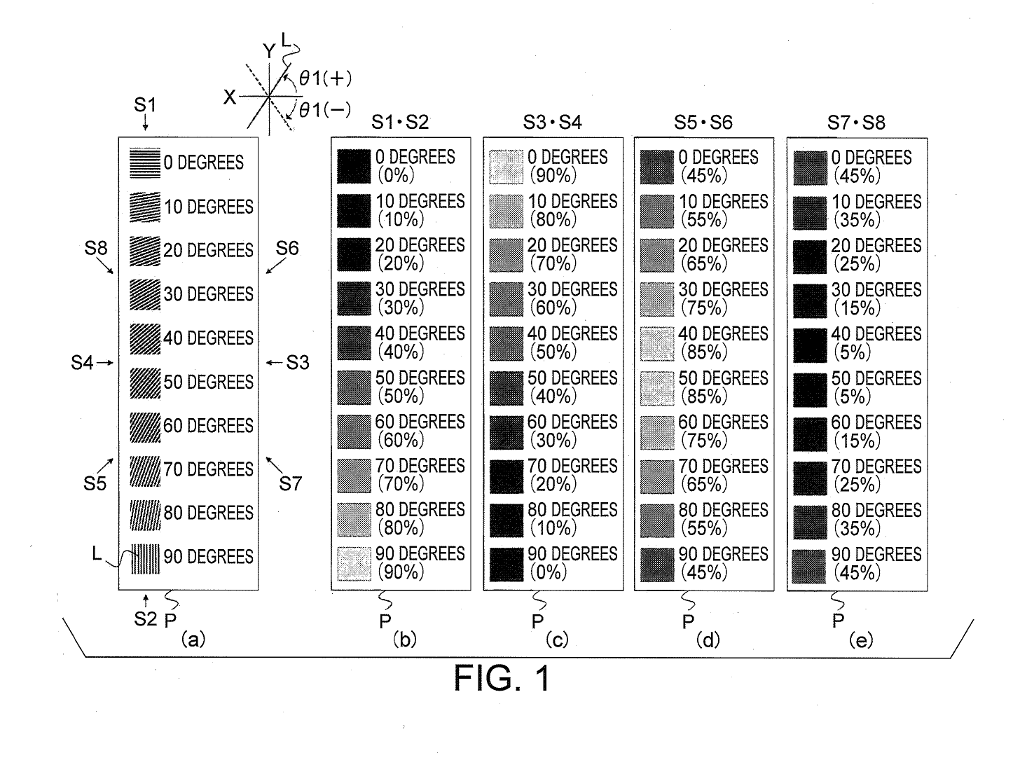

The concept of the present invention will be described first with reference to FIG. 1. FIG. 1(a) illustrates a printed matter P on which periodical (with equal image line widths and equal image line pitches) raised image lines L are arranged in identical rectangles while being tilted in steps of 10° at angles from 10° to 90°. The image lines L of the printed matter P have an image line width of 0.16 mm, an image line pitch of 0.25 mm, and an image line height of 0.03 mm. An angle θ1 of the image lines L of the present invention indicates an angle with respect to the X axis (angle: 0°), as shown in FIG. 1.

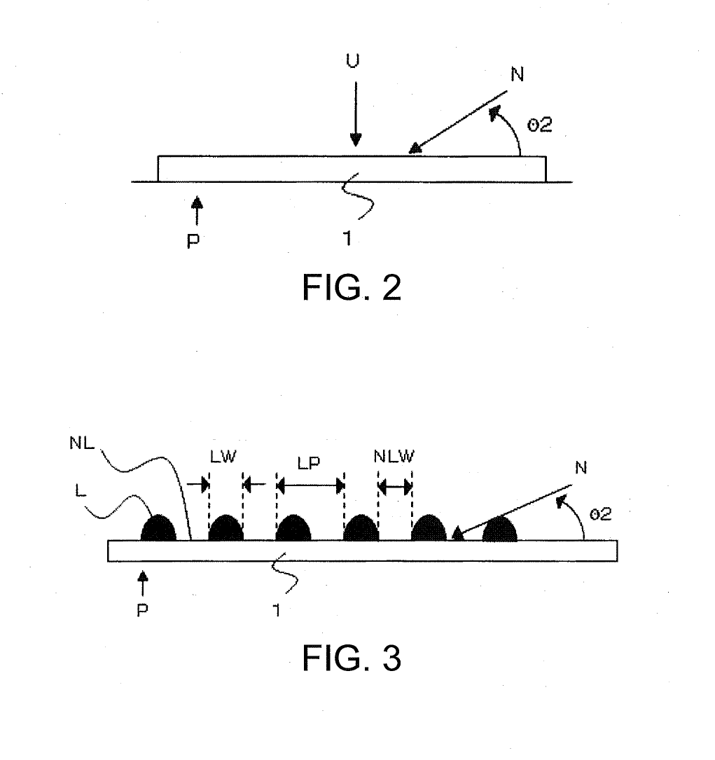

FIGS. 1(b) to 1(e) schematically show the visual densities of the image lines L formed in the rectangles of the printed matter P shown in FIG. 1(a) when visually recognized from predetermined observation directions. Degrees in the drawings indicate the angles of the image lines L. Parenthesized numbers indicate the visual densities of the rectangular images expressed as numerical values ranging from 0% to 90%. A visual density of 0% represents a state in which an image is visually recognized darkest as black. A visual density of 90% represents a state in which an image is visually recognized brightest as white. Visual densities of 40% and 50% represent a state in which an image is visually recognized as gray in halftone. Note that “rectangular image” of the present invention means an image visually recognizable from observation directions U and N shown in FIG. 2.

A rectangular image observed by the difference in the observation direction will be described. As shown in FIG. 2, when the printed matter P is visually recognized from immediately above in the observation direction U, the image lines are periodically formed in the rectangular images shown in FIG. 1(a). Since the line area ratios per unit area are equal, the rectangular images can visually be recognized as the same density. That is, the rectangular images are observed without differences between the visual densities.

A case in which the rectangles of the printed matter P shown in FIG. 2 are visually recognized obliquely from the observation direction N will be described next. Assume that the rectangles are visually recognized from first observation directions (observation directions S1 and S2 (Y-axis directions)) shown in FIG. 1(a). At an image line angle of 0°, the raised image lines L wholly occlude non-image lines NL, and the image is visually recognized as black. On the other hand, the larger the angle θ1 of the image lines L is, the larger the tilt of the image lines L is. For this reason, the occlusion amount of the non-image, lines NL by the image lines L gradually decreases. At an image line angle of 90°, the image lines L do not occlude the non-image lines NL at all, and the image is visually recognized as white. As a result, the rectangular images change the visual densities as 0% (black) at an image line angle of 0°, . . . , 40% (gray) at an image line angle of 40°, 50% (gray) at an image line angle of 50°, . . . , and 90% (white) at an image line angle of 90°. Hence, when a plurality of rectangles in which image lines are periodically provided are arranged adjacently, and the image line angle in the rectangle is changed in steps of 10°, as shown in FIG. 1(a), a gradation can visually be recognized from the observation direction N.

Assume that the rectangles are visually recognized from second observation directions (observation directions S3 and S4 (X-axis directions)) shown in FIG. 1(a). In this case, gradation images can be observed with visual densities of 90% (white) at an image line angle of 0°, . . . , 50% (gray) at an image line angle of 40°, 40% (gray) at an image line angle of 50°, and 0% (black) at an image line angle of 90°. As compared to the first observation directions, the visual densities of the rectangular images are inverted, and the gradation direction is also reversed.

Assume that the rectangles are visually recognized from third observation directions (visual recognition directions S5 and S6 (diagonal directions)) shown in FIG. 1(a). In this case, the visual densities are lowest in 85% (white) at image line angles of 40° and 50°. The visual densities gradually rise toward the smaller and larger image line angles, and become highest in 45% (gray) at image line angles of 0° and 90°. As compared to the first and second observation directions, since the rectangular images have different visual densities, a different gradation is observed.

Assume that the rectangles are visually recognized from fourth observation directions (visual recognition directions S7 and S8 (other diagonal directions)). In this case, the visual densities are highest in 5% (black) at image line angles of 40° and 50°. The visual densities gradually lower toward the smaller and larger image line angles, and become lowest in 45% (gray) at image line angles of 0° and 90°. As compared to the first, second, and third observation directions, since the rectangular images have different visual densities, a different gradation is observed. Note that in this present invention, the first to fourth observation directions will be referred to as “predetermined observation directions”.

The angle θ1 of the image lines L in the rectangles shown in FIG. 1(a) may range from 90° to 180°. Even in this arrangement, the images have the same visual densities as described above. For example, the image lines L in the rectangles shown in FIG. 1(a) are arranged sequentially from the upper side by setting an image line angle of 180° like 0°, changing an image line angle of 10° to 170°, 20° to 160°, 30° to 150°, 40° to 140°, 50° to 130°, 60° to 120°, 70° to 110°, and 80° to 100°, and remaining 90°. When the printed matter P is visually recognized from the first observation directions, the rectangles are visually recognized as in FIG. 1(b). When the printed matter P is visually recognized from the second observation directions, the rectangles are visually recognized as in FIG. 1(c). When the printed matter P is visually recognized from the third observation directions, the rectangles are visually recognized as in FIG. 1(e). When the printed matter P is visually recognized from the fourth observation directions, the rectangles are visually recognized as in FIG. 1(d). Hence, the image line angle of the image lines L in FIG. 1(a) may be set in the negative direction or may be set by combing the positive direction and the negative direction.

Hence, according to the concept of the present invention, the periodical image lines L are provided in a plurality of rectangles, the image line angle is changed in steps of a predetermined angle between the regions, and the rectangles are arranged adjacently. When the printed matter is visually recognized from immediately above, no density difference is generated between the rectangular images. However, when the printed matter is observed from a predetermined observation direction, the visual densities of the rectangular images change depending on the observation direction. Hence, a gradation can visually be recognized. Applying this concept to the arrangement of a latent image intaglio makes it possible to form a gradation in a latent image and/or a background image.

### (Image Line Design of Latent Image Intaglio)

An image line arrangement according to the present invention will be described next with reference to FIG. 3. FIG. 3 is a sectional view of a latent image intaglio 1 according to the present invention. The raised image lines L are formed on a base such as paper by intaglio printing, screen printing, foam printing, or the like. If the height of the image lines L is smaller than 0.01 mm, an observation angle θ2 to occlude the non-image lines NL by the image lines L when the printed matter P is observed from a predetermined observation direction is very small and the visibility of the latent image is poor. For this reason, the height of the image lines L is preferably set to 0.01 mm or more, and more preferably, ranges from 0.02 to 0.10 mm. The image lines L need to be arranged periodically in the same pitch and same image line width. An image line width LW of the image lines L can be 0.05 to 0.3 mm, and preferably, 0.1 to 0.2 mm. An image line pitch LP of the image lines L can be 0.1 to 0.6 mm, and preferably, 0.2 to 0.3 mm. However, when an image line width NLW of the non-image lines NL is smaller than 0.02 mm, printing failures such as image line crowding or unwiped portion readily occurs at the time of printing. For this reason, the image line width NLW of the non-image lines NL is preferably 0.02 mm or more. Hence, the latent image intaglio 1 of the present invention can be designed by appropriately combining the above-described image line width, image line pitch, and image line height.

The ratio of the image line width LW of the image lines L to the non-image line width NLW is preferably image line width LW:non-image line width NLW=1:1 to 3:1. This is because if the ratio of the image line width LW is higher than the above-mentioned ratio, the latent image in the latent image intaglio 1 becomes dark, resulting in constraints on design. On the other hand, if the ratio of the image line width LW is lower than the above-described ratio, the non-image lines NL cannot be occluded by the image lines L when visually recognizing the latent image intaglio 1 at a predetermined observation angle. However, this does not apply when the image lines L are formed thick or thin in part of the latent image intaglio 1 as a camouflage pattern.

### First Embodiment

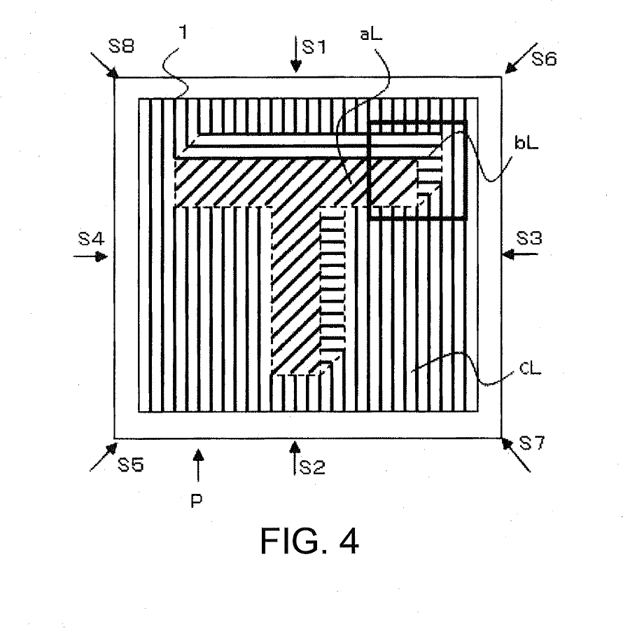

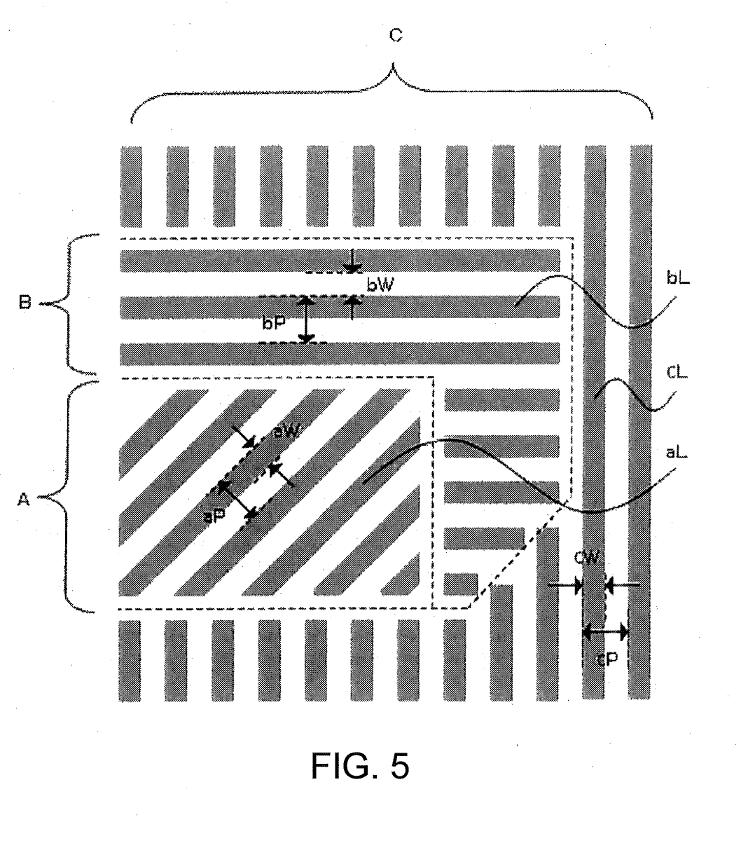

The arrangement of a latent image intaglio 1 in a printed matter P according to the first embodiment of the present invention will be described next. FIG. 4 shows the arrangement of the latent image intaglio 1 according to the first embodiment. As the first characteristic feature of the first embodiment, the latent image intaglio 1 is formed from a first plane A and a second plane B, which form a latent image portion, and a background portion C. FIG. 5 is an enlarged view of a rectangle shown in FIG. 4. Image lines aL, bL, and cL are periodically arranged on the first plane A, the second plane B, and the background portion C, respectively. At this time, an image line width aW of the image lines aL, an image line width bW of the image lines bL, and an image line width cW of the image lines cL are equal. In addition, an image line pitch aP of the image lines aL, an image line pitch bP of the image lines bL, and an image line pitch cP of the image lines cL are equal. The image lines aL, bL, and cL have the same image line height.

As the second characteristic feature of the first embodiment, the arrangement angles of the image lines aL, bL, and cL are different. Hence, when the two characteristic features are used, a shade image is added to the latent image when visually recognized from a predetermined observation direction, and a latent image with a depth can three-dimensionally visually be recognized, as in the concept of the first embodiment, and the visibility of the latent image further improves. On the other hand, when visually recognized at a predetermined observation angle, the latent image formed from the first plane A and the second plane B and the background image formed from the background portion C attain different visual densities, and advanced authenticity determination can be performed. Note that an image visually recognized when the latent image intaglio 1 of the present invention is observed from an observation direction U, as in FIG. 2, will be referred to as a “visible image”. When the latent image intaglio 1 is observed from an observation direction N in FIG. 2 in predetermined observation directions (first to fourth observation directions) in FIG. 4, an image visually recognized in the region of the first plane A will be referred to as a “latent image”, an image visually recognized in the region of the second plane B as a “shade image”, and an image visually recognized in the region of the background portion C as a “background image”.

### (Image Line Angle and Visual Density)

For example, Table 1 shows representative angles of the image lines in the first plane A, the second plane B, and the background portion C of the latent image intaglio 1 according to the first embodiment. The image line angle is changed in steps of 45° between the first plane A, the second plane B, and the background portion C. This attains preferable combinations because large density differences can visually be recognized between the regions when visually recognized from each predetermined observation direction in Table 2. Note that the image line angle in the first plane A is fixed to 45° in levels 1 and 2, the image line angle in the background portion C is fixed to 45° in levels 3 and 4, and the image line angle in the second plane B is fixed to 45° in levels 5 and 6 while setting the image line angles in other regions to 0° or 90°. The image line angle need not always be changed in steps of 45° between the regions, and is appropriately designed while confirming the gradation of the printed matter.

TABLE 1

| | First plane | Second plane | Background |
|---|---|---|---|
| Region | A | B | portion C |
| Image lines | aL | bL | cL |
| Level 1 | 45° | 0° | 90° |
| Level 2 | 45° | 90° | 0° |
| Level 3 | 90° | 0° | 45° |
| Level 4 | 0° | 90° | 45° |
| Level 5 | 90° | 45° | 0° |
| Level 6 | 0° | 45° | 90° |

Table 2 shows the visual density of each region when the latent image intaglio made based on each level in Table 1 is visually recognized from predetermined observation directions.

TABLE 2

| | Region | A | B | C |
|---|---|---|---|---|
| Level | Observation direction | aL | bL | cL |
| Level 1 | S1•S2 (first) | 45% | 0% | 90% |
| | S3•S4 (second) | 45% | 90% | 0% |
| | S5•S6 (third) | 0% | 45% | 45% |
| | S7•S8 (fourth) | 90% | 45% | 45% |
| Level 2 | S1•S2 (first) | 45% | 90% | 0% |
| | S3•S4 (second) | 45% | 0% | 90% |
| | S5•S6 (third) | 0% | 45% | 45% |
| | S7•S8 (fourth) | 90% | 45% | 45% |
| Level 3 | S1•S2 (first) | 90% | 0% | 45% |
| | S3•S4 (second) | 0% | 90% | 45% |
| | S5•S6 (third) | 45% | 45% | 90% |
| | S7•S8 (fourth) | 45% | 45% | 0% |
| Level 4 | S1•S2 (first) | 0% | 90% | 45% |
| | S3•S4 (second) | 90% | 0% | 45% |
| | S5•S6 (third) | 45% | 45% | 90% |
| | S7•S8 (fourth) | 45% | 45% | 0% |
| Level 5 | S1•S2 (first) | 90% | 45% | 0% |
| | S3•S4 (second) | 0% | 45% | 90% |
| | S5•S6 (third) | 45% | 90% | 45% |
| | S7•S8 (fourth) | 45% | 0% | 45% |
| Level 6 | S1•S2 (first) | 0% | 45% | 90% |
| | S3•S4 (second) | 90% | 45% | 0% |
| | S5•S6 (third) | 45% | 90% | 45% |
| | S7•S8 (fourth) | 45% | 0% | 45% |

As shown in Table 2, in the latent image intaglio of each level, large density differences are generated between the visual densities of a latent image, a shade image, and a background image visually recognized from a predetermined observation direction. This increases the identifiability of each of the latent image and the shade image and attains preferable combinations.

As is apparent from FIGS. 1(b) to 1(e), an image is visually recognized as “black” at an image line angle of 0° to 20°, as “gray” at an image line angle of 30° to 60°, and as “white” at an image line angle of 70° to 90°. Hence, a combination may be obtained by setting the image line angle in any one of the regions of the first plane A, the second plane B, and the background portion C to 0° to 25°, the image line angle in the second region to 25° to 65°, and the image line angle in the third region to 65° to 90°. Preferably, when the angle of any one of the image line regions is set to 0°, one of the remaining regions is set to 35° to 45°, and the other is set to 70° to 90°. This makes it possible to form black, gray, and white latent images with high contrast.

In particular, when 0° and 90° are used as the image line angles of the first plane A, the second plane B, and the background portion C, the image line angles of the remaining regions are appropriately selected within the range of 25° to 65°. This is because any image is visually recognized as gray at an image line angle to 25° to 65° even when visually recognized from a predetermined observation direction, and density differences with respect to the other regions are generated.

If the image line angle differences between the image lines aL, bL, and cL are 10° or less, the visual density differences when visually recognized from a predetermined observation direction are also small. Hence, no visual density differences are generated between the regions. The image line angles in the first plane A, the second plane B, and the background portion C are preferably set to at least 20° or more. Note that image lines in the negative direction may be used, or image lines in the negative direction and those in the positive direction may be combined. In FIGS. 4 and 5, each image line is represented by a straight line. However, an image line may be formed from a dotted line, a broken line, a double line, a wavy line, a zigzag line, a curved line, or the like.

### (Arrangement of Second Plane)

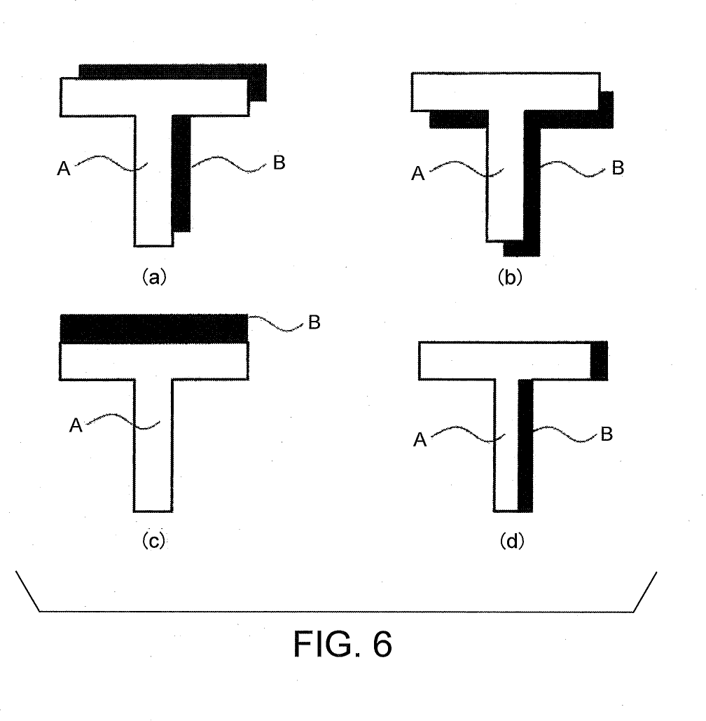

The arrangement of the second plane B will be described next with reference to FIG. 6. In FIGS. 6(a) to 6(c), the second plane B is provided outside the first plane A. The second plane B is provided on the upper right side in FIG. 6(a), on the lower right side in FIG. 6(b), or on the upper side in FIG. 6(c). On the other hand, in FIG. 6(d), the second plane B is provided inside the first plane A. The arrangement of the first plane A and the second plane B is appropriately selected from the above-described arrangements. Alternatively, another arrangement may be used.

### (Arrangement in Main Observation Direction)

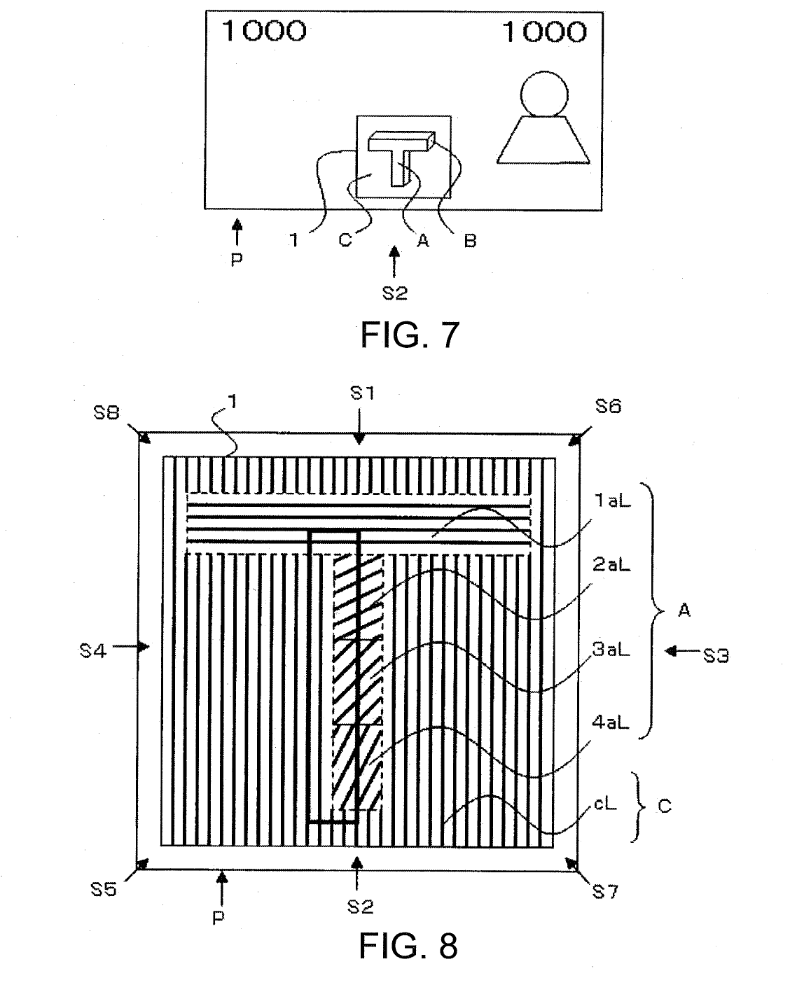

FIG. 7 shows the printed matter P provided with the latent image intaglio 1 according to the first embodiment. In general, when visually recognizing the printed matter P, the observer often opposes and observes the printed matter with its printed pattern facing up. Hence, the direction (to be referred to as a main observation direction) in which the printed matter P is first observed is an observation direction S2 in many cases. For this reason, it is preferable to use an arrangement in which the visibility of the latent image and the shade image is highest when visually recognized from the observation direction S2. More specifically, an arrangement in which the visibility of the latent image and the shade image in the main observation direction is high is obtained by providing the second plane B diagonally above the first plane A, as shown in FIG. 6(a), and setting the image line angle in the second plane B to 0° to visually recognize a black image, as in levels 1 and 3 of Table 1. This is because as a characteristic feature, when a black shade image is located behind an object, the latent image is readily enhanced. Hence, an arrangement in which a shade image can visually be recognized as black behind a latent image when visually recognized from the main observation direction is preferable. However, since the main observation direction changes depending on an individual, the arrangement of the second plane B is appropriately adjusted.

Note that the base preferably has a light hue (whitish color) such as white or yellow, and ink of a dark color (blackish color) such as black, brown, brownish color, or purple is preferably used to form the image lines. This is because the printed matter P of the present invention aims at three-dimensionally visually recognizing a latent image by a shade image when visually recognized from a predetermined observation direction, and the density difference between the base and the image lines is preferably large. Note that the latent image lines need not use an expensive ink material having a special effect, and a general blackish ink material suffices. However, a function such as a color change or photoluminescence may be imparted as needed using an optically variable ink, pearl ink, gloss ink, metal ink, transparent ink, or the like.

### Second Embodiment

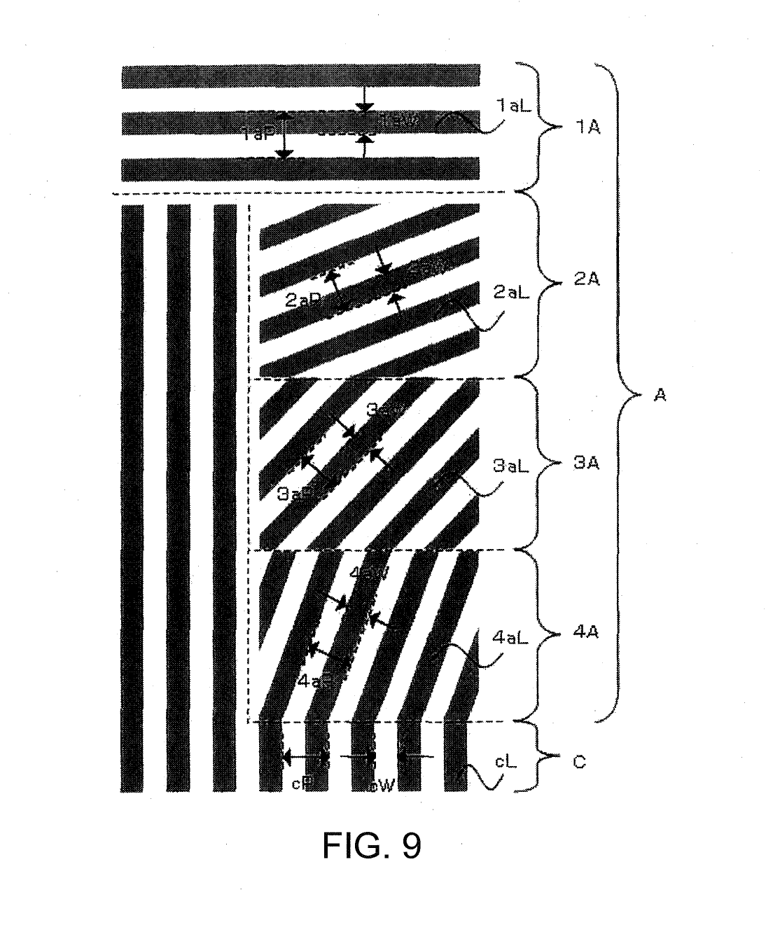

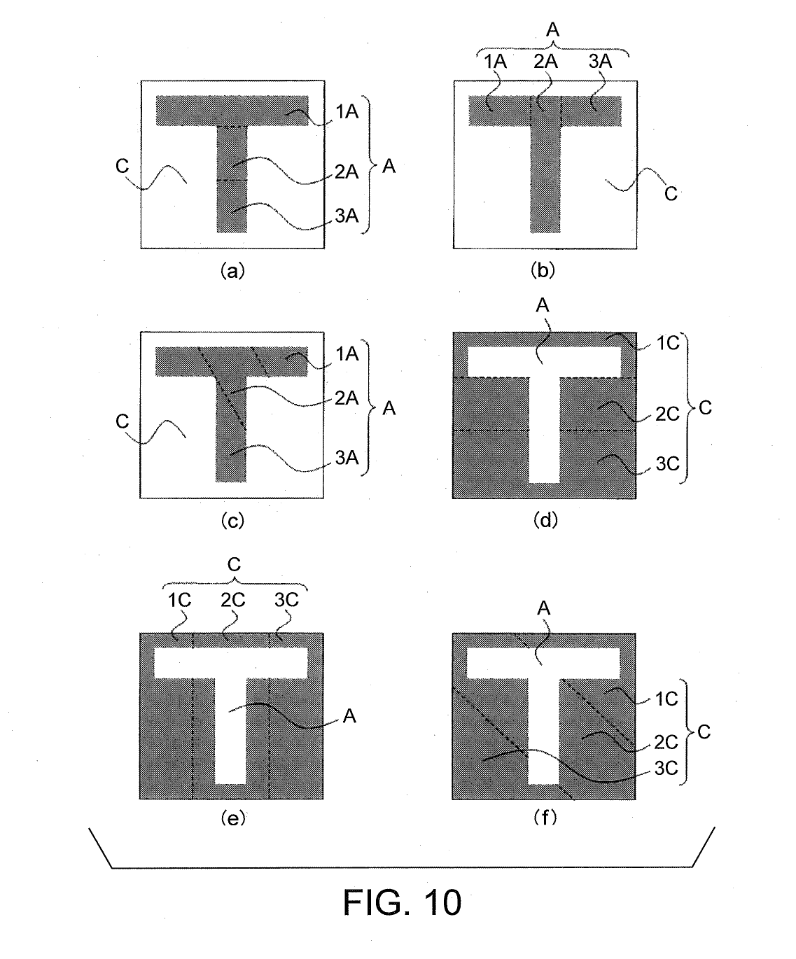

The arrangement of a latent image intaglio 1 according to the second embodiment of the present invention will be described next. FIG. 8 shows the arrangement of the latent image intaglio 1 according to the second embodiment. As a characteristic feature of the second embodiment, the latent image intaglio 1 is formed from a latent image portion A and a background portion C, and the region of the latent image portion A is divided into a plurality of parts to form a gradation in the latent image portion A. FIG. 9 is an enlarged view of a rectangle shown in FIG. 8. The latent image portion A includes four regions, that is, a first region 1A, a second region 2A, a third region 3A, and a fourth region 4A from above along the horizontal direction. Image lines 1aL in the first region 1A, image lines 2aL in the second region 2A, image lines 3aL in the third region 3A, image lines 4aL in the fourth region, and image lines cL in the background portion C are periodically arranged. At this time, an image line width 1aW of the image lines 1aL, an image line width 2aW of the image lines 2aL, an image line width 3aW of the image lines 3aL, an image line width 4aW of the image lines 4aL, and an image line width cW of the image lines cL are equal. In addition, an image line pitch 1aP of the image lines 1aL, an image line pitch 2aP of the image lines 2aL, an image line pitch 3aP of the image lines 3aL, an image line pitch 4aP of the image lines 4aL, and an image line pitch cP of the image lines cL are equal. The image lines 1aL, 2aL, 3aL, 4aL, and cL have the same image line height.

As the second characteristic feature of the second embodiment, the arrangement angle is changed in steps of a predetermined angle between the image lines 1aL, 2aL, 3aL, 4aL, and cL. Hence, when the latent image intaglio 1 is formed using the above-described two characteristic features, a latent image having a gradation can visually be recognized when visually recognized from a predetermined observation direction, and advanced authenticity determination can be performed. Note that in the second embodiment, an image observed when the latent image intaglio 1 is visually recognized from immediately above in an observation direction U, as in FIG. 2, will be referred to as a “visible image”. On the other hand, an image visually recognized by the region of the latent image portion A when the latent image intaglio 1 is visually recognized from predetermined observation directions (first to fourth observation directions) of FIG. 8 in an observation direction N in FIG. 2 will be referred to as a “latent image”. On the other hand, an image visually recognized by the region of the background portion C will be referred to as a “background image”.

### (Image Line Angle and Visual Density)

Table 3 shows an example in which four regions are provided in the latent image portion A of the latent image intaglio 1 of the present invention, and the image lines are arranged in the respective regions at different angles. In levels 1 and 2, the image line angle is changed in steps of 22.5° between the regions of the latent image portion A. In levels 3 and 4, the image line angle is changed in steps of 15° between the regions of the latent image portion A. To obtain an effective gradation, it is important to change the image line angle by a predetermined angle or more. The image line angle need not always be changed in steps of a predetermined angle between the regions, and is appropriately designed while confirming the gradation of the printed matter P. Note that as indicated by levels 3 and 4 in Table 3, image lines may be formed in the plurality of regions of the latent image portion A at an angle of 45° or less, and image lines may be formed in the plurality of regions of the background portion C at an angle of 45° or less.

TABLE 3

| | Latent image portion A | | | | Background |
|---|---|---|---|---|---|
| Region | 1A | 2A | 3A | 4A | portion C |
| Image lines | 1aL | 2aL | 3aL | 4aL | cL |
| Level 1 | 0° | 22.5° | 45° | 67.5° | 90° |
| Level 2 | 90° | 67.5° | 45° | 22.5° | 0° |
| Level 3 | 0° | 15° | 30° | 45° | 90° |
| Level 4 | 90° | 75° | 60° | 45° | 0° |

Table 4 shows the visual density of each region when the latent image intaglio made based on each level in Table 3 is visually recognized from predetermined observation directions. Note that in the second embodiment, image lines in the latent image portion A and those in the background portion C, which have the largest image line angle difference, will be referred to as “reference image lines”. More specifically, in level 1 of Table 3, the reference image lines 1aL in the latent image portion A have an angle of 0°, and the reference image lines cL in the background portion C have an angle of 90°. In this way, the image lines arrayed in one of the plurality of divided regions of the latent image portion A and the image lines arrayed in one of the plurality of divided regions of the background portion C preferably have a relative angle difference of 50° or more.

TABLE 3

| | | Latent image portion A | | | | Background |
|---|---|---|---|---|---|---|
| | Observation | 1A | 2A | 3A | 4A | portion C |
| Level | direction | 1aL | 2aL | 3aL | 4aL | cL |
| Level | S1•S2 (first) | 0% | 22.5% | 45% | 67.5% | 90% |
| 1 | S3•S4 | 90% | 67.5% | 45% | 22.5% | 0% |
| | (second) | | | | | |
| | S5•S6 (third) | 45% | 67.5% | 90% | 67.5% | 45% |
| | S7•S8 | 45% | 22.5% | 0% | 22.5% | 45% |
| | (fourth) | | | | | |
| Level | S1•S2 (first) | 90% | 67.5% | 45% | 22.5% | 0% |
| 2 | S3•S4 | 0% | 22.5% | 45% | 67.5% | 90% |
| | (second) | | | | | |
| | S5•S6 (third) | 45% | 67.5% | 90% | 67.5% | 45% |
| | S7•S8 | 45% | 22.5% | 0% | 22.5% | 45% |
| | (fourth) | | | | | |
| Level | S1•S2 (first) | 0% | 15% | 30% | 45% | 90% |
| 3 | S3•S4 | 90% | 45% | 30% | 15% | 0% |
| | (second) | | | | | |
| | S5•S6 (third) | 45% | 60% | 75% | 90% | 45% |
| | S7•S8 | 45% | 30% | 15% | 0% | 45% |
| | (fourth) | | | | | |
| Level | S1•S2 (first) | 90% | 45% | 30% | 15% | 0% |
| 4 | S3•S4 | 0% | 15% | 30% | 45% | 90% |
| | (second) | | | | | |
| | S5•S6 (third) | 45% | 60% | 75% | 90% | 45% |
| | S7•S8 | 45% | 30% | 15% | 0% | 45% |
| | (fourth) | | | | | |

As is apparent from Table 4, in each level, the visual density changes in any observation direction when the latent image and the background image are visually recognized from predetermined observation directions (first to fourth observation directions). As a result, the latent image can visually be recognized as a gradation. Note that the latent image cannot visually be recognized in a visible image when the latent image intaglio according to the second embodiment is observed from immediately above.

### (Preference to Gradation of Latent Image)

Levels 1 and 2 indicate an example in which the gradation effect is high (tonality is high). More specifically, since the image lines in the latent image portion A are formed while changing the image line angle in steps of 22.5° within the range of 0° to 67.5°, a density difference of 22.5% is visually recognized stepwise within the range of 67.5% between the first observation directions and the second observation directions, and the gradation effect is enhanced. Note that since the image line angle is changed in steps of 22.5° between the latent image portion A and the background portion C, and the density difference between the latent image and the background image is also 22.5%, the identifiability of each image is also high. Hence, when the image line angle is set to 20° or more in the regions of the latent image portion A and the background portion B, the latent image and the background image can be identified. Note that even when the latent image difference between the regions is smaller than 20°, a gradation effect can be obtained, as a matter of course.

### (Preference to Identifiability of Latent Image and Background Image)

On the other hand, levels 3 and 4 indicate an example in which the latent image and the background image have a high identifiability, and a gradation of the latent image can also visually be recognized. More specifically, when the image lines in the latent image portion A and those in the background portion C have a difference of 45°, a density difference of 45% is obtained between the first observation directions and the second observation directions. In addition, when the image lines in the latent image portion A are formed while changing the image line angle in steps of 15° within the range of 0° to 45°, a density difference of 15% can visually be recognized stepwise within the range of 45% between the first observation directions and the second observation directions. Hence, the latent image can visually be recognized as an image having a gradation. Hence, when an image line angle of 0° is set for one of the latent image portion A and the background portion C, whereas an image line angle of 90° is set for the other, and the image line angle is changed stepwise within the range of 45° between the regions of the latent image portion A, the identifiability of the latent image and the background image can be raised, and the gradation of the latent image can also visually be recognized.

### (Forms of Latent Image and Background Image)

In FIGS. 8 and 9, each image line is represented by a straight line. However, an image line may be formed from a dotted line, a broken line, a double line, a wavy line, a zigzag line, a curved line, or the like. Tables 3 and 4 show examples in which the latent image portion A is divided into four parts. However, the number of divisions need only be at least two. To visually recognize a more effective gradation, the number of divisions is preferably three or more. The background portion C may also be divided to change the image line angle.

Note that in Table 3, the image line angle ranges from 0° to 90°. However, the image line angle may range from 90° to 180°. Additionally, as shown in Table 4, an example of the highest visual density is 0%. However, as shown in FIG. 1, no remarkable visual density difference is generated within the range of 0% to 20% when visually recognized from a predetermined observation direction. Hence, an image line angle for the highest visual density is appropriately selected from the range of 0° to 20°.

### (Region Division of Latent Image Portion and Background Portion)

The arrangement of the latent image portion A and the background portion C will be described next with reference to FIG. 10. FIGS. 10(a) to 10(c) illustrate examples in which the latent image portion A is divided, and FIGS. 10(d) to 10(f) illustrate examples in which the background portion C is divided. In the examples shown in FIGS. 10(a) to 10(f), the latent image portion A and the background portion C are divided. Arrangements for dividing the portions in the vertical direction, arrangements for dividing the portions in the horizontal direction, and arrangements for dividing the portions in an oblique direction, and the like are available, and the dividing range is appropriately selected. Note that the arrangements of the latent image portion A shown in FIGS. 10(a) to 10(c) and the arrangements of the background portion C shown in FIGS. 10(d) to 10(f) may be combined. As for the region division of the latent image portion A and the background portion C, examples have been described above in which the plurality of divided regions of each of the latent image portion A and the background portion C comprise three regions. However, the number of region divisions can be an arbitrary number as long as it is at least two. Dividing the latent image portion A and/or the background portion C into three or more regions is a preferable form of the present invention because a clear gradation can visually be recognized.

### (Arrangement in Main Observation Direction)

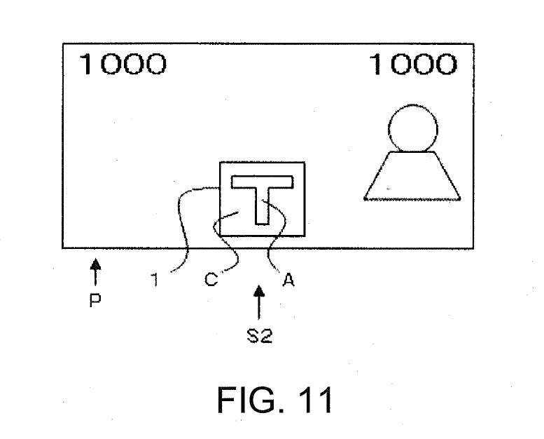

FIG. 11 shows the printed matter P provided with the latent image intaglio 1 according to the second embodiment. In general, when visually recognizing the printed matter P, the observer often opposes and observes the printed matter with its printed pattern facing up. Hence, the direction (to be referred to as a main observation direction) in which the printed matter P is first observed is an observation direction S2 in many cases. For this reason, it is preferable to use an arrangement in which a highest gradation effect of the latent image can be obtained when visually recognized from the observation direction S2. More specifically, the region of the latent image portion A is divided in the horizontal direction, as shown in FIG. 10(a), and the image line angle of the uppermost one of the divided regions of the latent image portion A is set to 0°, as in levels 1 and 3 of Table 1. This is because when visually recognized from the observation direction S2, a gradation can be more easily visually recognized when black easiest to visually recognize is arranged at a distant position. Hence, when visually recognized from the main observation direction, the gradation of the latent image can visually be recognized as a gradation that is black on the far side and white on the near side.

The base preferably has a light hue (whitish color) such as white or yellow, and ink having a dark hue (blackish color) such as black, brown, brownish color, or purple is preferably used to form the image lines. This is because the printed matter according to the second embodiment aims at visually recognizing a latent image and/or a background image having a gradation when visually recognized from a predetermined observation direction, and the density difference between the base and the image lines is preferably large. Note that the latent image lines needs to use neither a material having a special effect nor an expensive ink material, and a general blackish ink material suffices. However, a function such as a color change or photoluminescence may be imparted as needed using an optically variable ink, pearl ink, gloss ink, metal ink, transparent ink, or the like.

### Example 1

Examples of the present invention will be described. Examples 1 to 6 to be described later are examples of the printed matter P including the latent image intaglio 1 according to the first embodiment of the present invention. The printed matter P of Example 1 indicates an example in which the visibility of the latent image and the shade image is high in the main observation direction. As shown in FIG. 4, the latent image intaglio 1 was formed on the printed matter P by intaglio printing. A white paper sheet was used as the base, and the intaglio image lines were formed by black ink. The latent image intaglio 1 included three regions, that is, the first plane A, the second plane B, and the background portion C, as shown in FIGS. 4 and 5. The second plane B was arranged adjacently on the upper right side of the first plane A, as shown in FIG. 6(a).

The image line width aW of the image lines aL, the image line width bW of the image lines bL, and the image line width cW of the image lines cL were set to 0.15 mm. The image line pitch aP of the image lines aL, the image line pitch bP of the image lines bL, and the image line pitch cP of the image lines cL were set to 0.25 mm. The image line height of the image lines aL, bL, and cL was set to 0.03 mm. As for the image line angles in the respective regions, the image lines aL in the first plane A were set to 45°, the image lines bL in the second plane B were set to 0°, and the image lines cL in the background portion C were set to 90°, as in level 1 of Table 1 described above.

When the latent image intaglio 1 having such an arrangement is made, and the latent image intaglio 1 shown in FIG. 4 is visually recognized from the observation direction U, that is, from immediately above, the latent image cannot visually be recognized. On the other hand, when the latent image intaglio 1 shown in FIG. 4 is visually recognized from a predetermined observation direction, the regions have visual densities as in level 1 of Table 2 described above.

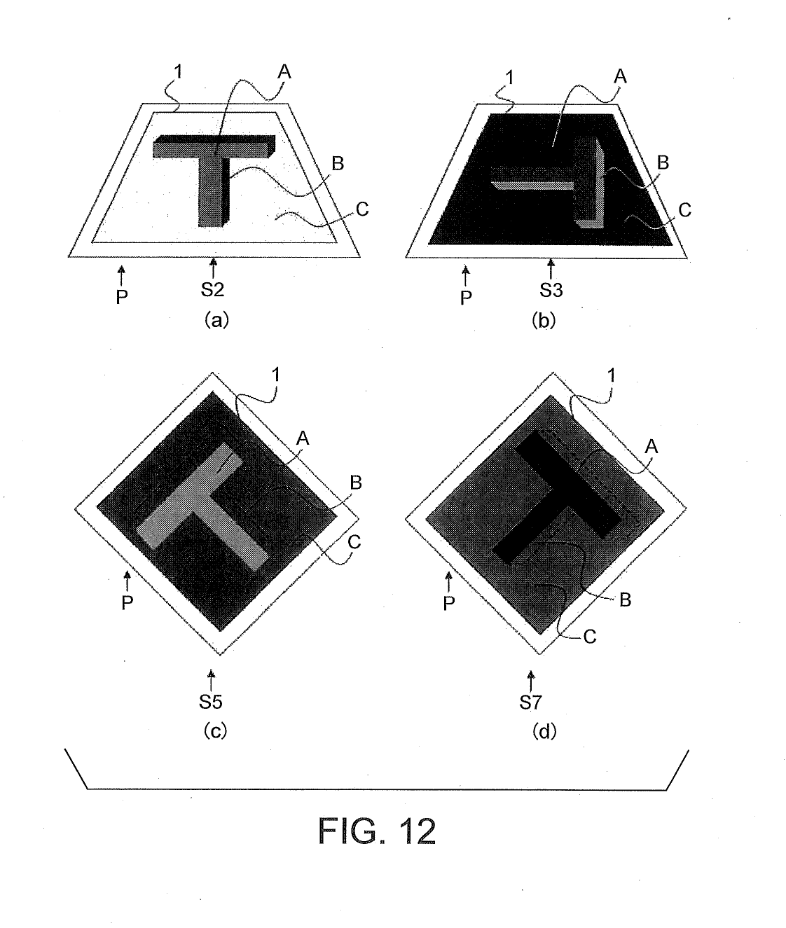

FIG. 12 shows schematic views illustrating states in which the latent image intaglio 1 shown in FIG. 4 is visually recognized from predetermined observation directions. FIG. 12(a) is a view observed when the latent image intaglio is visually recognized from a first observation direction (S2). The latent image looks gray with a visual density of 45%, the shade image looks black with a visual density of 0%, and the background image looks white with a visual density of 90%. The regions have different visual densities. FIG. 12(b) is a view observed when the latent image intaglio is visually recognized from a second observation direction (S3). The latent image looks gray with a visual density of 45%, the shade image looks white with a visual density of 90%, and the background image looks black with a visual density of 0%. The regions have different visual densities. FIG. 12(c) is a view observed when the latent image intaglio is visually recognized from a third observation direction (S5). The latent image looks white with a visual density of 90%, the shade image looks gray with a visual density of 45%, and the background image looks gray with a visual density of 45%. Only the latent image has a different visual density. FIG. 12(d) is a view observed when the latent image intaglio is visually recognized from a fourth observation direction (S7). The latent image looks black with a visual density of 0%, the shade image looks gray with a visual density of 45%, and the background image looks gray with a visual density of 45%. Only the latent image has a different visual density.

As a result, in the first observation direction (S2) and the second observation direction (S3), the regions have different visual densities. When a shade image is added to the latent image, the latent image standing out three-dimensionally can visually be recognized. Hence, the visibility of the latent image can further be improved. Since the first observation direction includes the main observation direction, a more effective arrangement can be obtained. On the other hand, in the third observation direction (S5) and the fourth observation direction (S7), only the latent image can visually be recognized. Hence, since the latent image and/or the shade image having a different visual density can visually be recognized from all observation directions, advanced authenticity determination can be performed. Note that each of FIGS. 12(a) to 12(d) illustrates one of predetermined observation directions. Even from the other observation direction (the relationship of the observation directions S1 and S2), a latent image having the same visual density can be observed, although the orientation of the image is inverted.

### Example 2

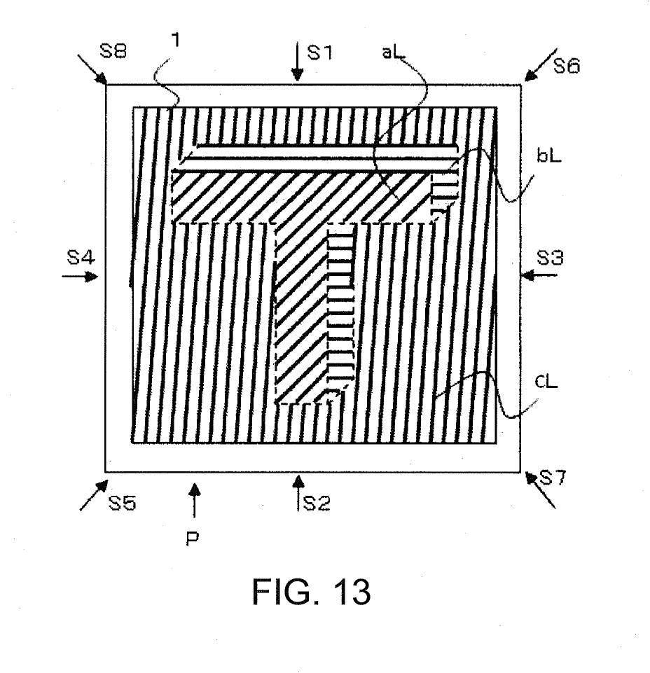

Example 2 is an example in which the wiping direction in intaglio printing is taken into consideration. Note that since Example 2 is a modification of Example 1, a description of the same parts will be omitted, and only different parts will be explained. Generally, in intaglio printing, since intaglio ink for intaglio image lines on an intaglio printing plate is wiped by a wiping roller, image lines conforming to the wiping direction (same direction) are known to have low image line reproducibility. For example, if the image line direction of the image lines cL in the background portion C of Example 1 shown in FIG. 4 is the same as the wiping direction, the image line reproducibility of the image lines cL may be undesirable. To prevent this, in Example 2, as shown in FIG. 13, the image line angle of the image lines cL in the background portion C was set to 75° to prevent it from conforming to the wiping direction, thereby improving the image line reproducibility of intaglio printing. Note that in a visually recognized state from a predetermined observation direction, the same effect as in FIG. 12 was obtained because no remarkable density difference existed between an image line angle of 75° and an image line angle of 90°, as shown in FIG. 1, and advanced authenticity determination could be performed. When the image line angle of the image lines cL is set to 75°, the image line angle of the image lines aL may be set to 37.5°.

### Example 3

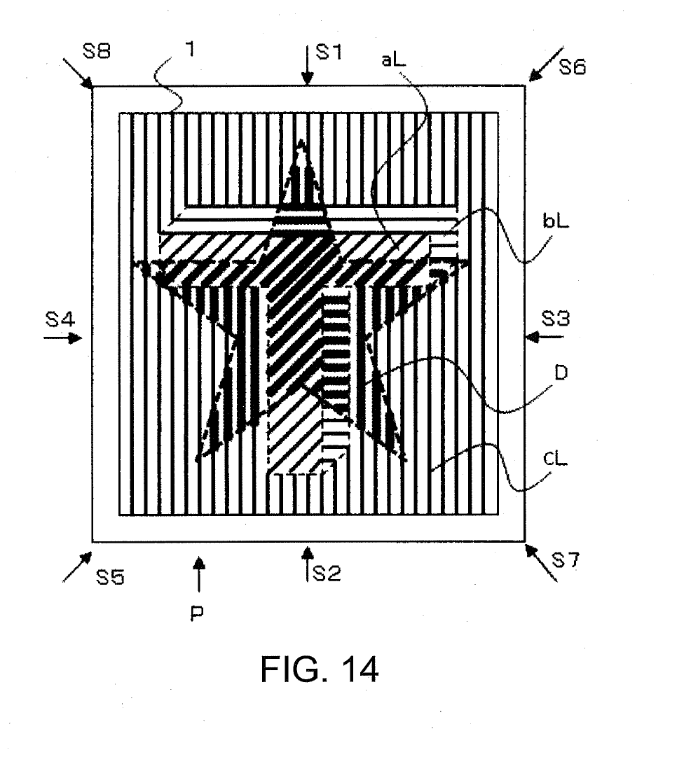

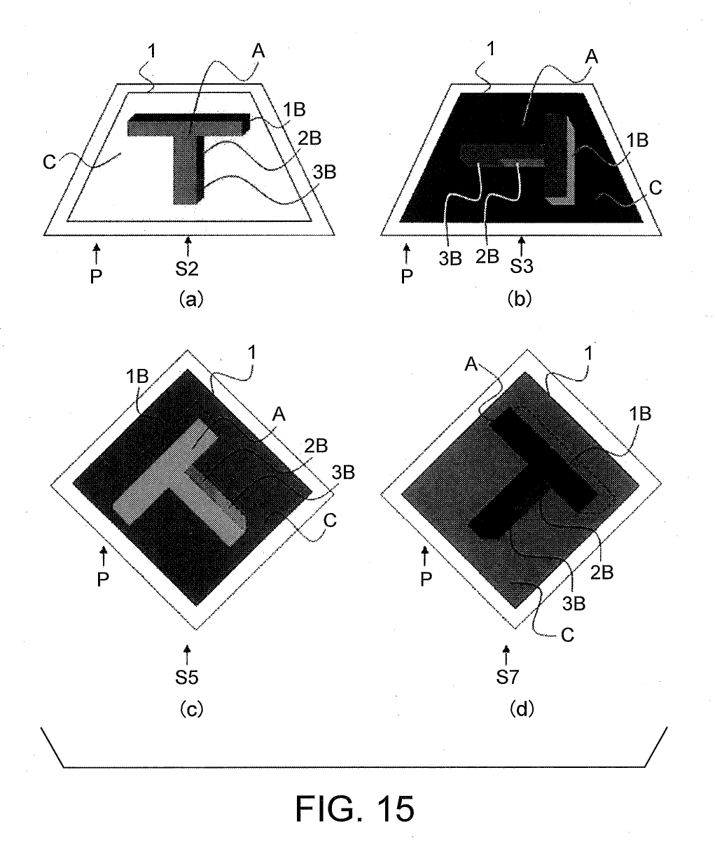

Example 3 is an example in which the region of the second plane B is divided into a plurality of regions, and the image line angle is changed between the regions. Note that since Example 3 is a modification of Example 1, a description of the same parts will be omitted, and only different parts will be explained. For example, as shown in FIG. 14, the second plane B was divided into three regions, that is, a first region 1B, a second region 2B, and a third region 3B. At this time, the image line angle of image lines 1bL in the first region 1B of the second plane B was set to 0°, the image line angle of image lines 2bL in the second region 2B was set to 15°, and the image line angle of image lines 3bL in the third region 3B was set to 30°. As shown in FIG. 15, in a visually recognized state from a predetermined observation direction, a gradation was formed because of the density difference in the shade image, as is apparent from comparison with FIG. 12, and the three-dimensional latent image could be more conspicuously visually recognized. Hence, advanced authenticity determination could be performed. Note that the number of divisions and the image line angles in the second plane B are appropriately designed.

### Example 4

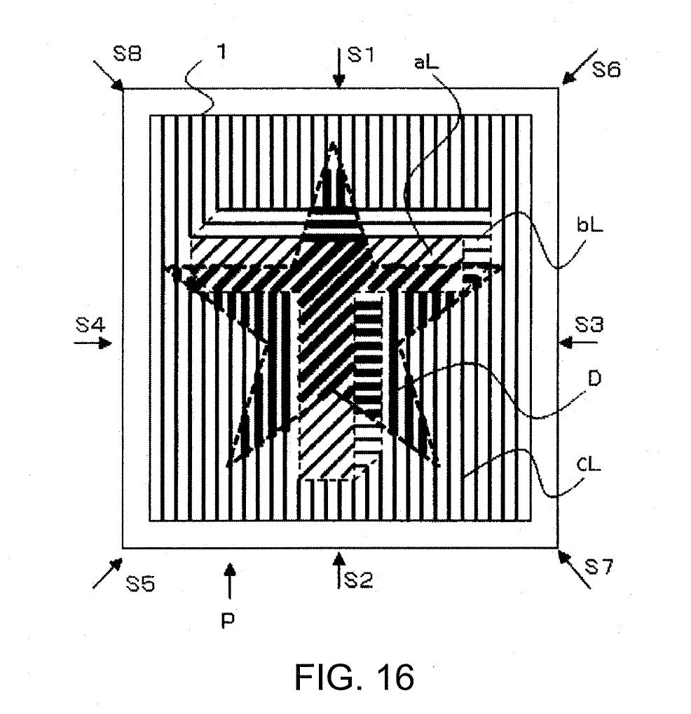

Example 4 is an example in which an arrangement for camouflaging the first plane A and the second plane B when the latent image intaglio 1 of the present invention is observed from the observation direction U, that is, from immediately above is added. Note that since Example 4 is a modification of Example 1, a description of the same parts will be omitted, and only different parts will be explained. As shown in FIG. 16, a camouflage portion D was provided in the first plane A, the second plane B, and the background portion C in addition to the arrangement of Example 1, and the image line width was set to 0.18 mm only in the camouflage portion D. With this arrangement, when the latent image intaglio 1 was observed from immediately above, a camouflage image “star” could visually be recognized, and the camouflage properties of the first plane A and the second plane B could be improved. In a visually recognized state from a predetermined observation direction, the same effect as in FIG. 12 was obtained, and advanced authenticity determination could be performed. Note that an example in which the image lines in the camouflage portion D are made thicker than the other image lines has been described. However, the same effect as described above can be obtained even when the image lines are made thinner than the image lines aL, bL, and cL as long as the area ratio per unit area is different. As described above, a camouflage image may be formed by changing the area ratio per unit length for at least some of image lines formed in the latent image portion and the background portion or in the latent image portion or the background portion.

### Example 5

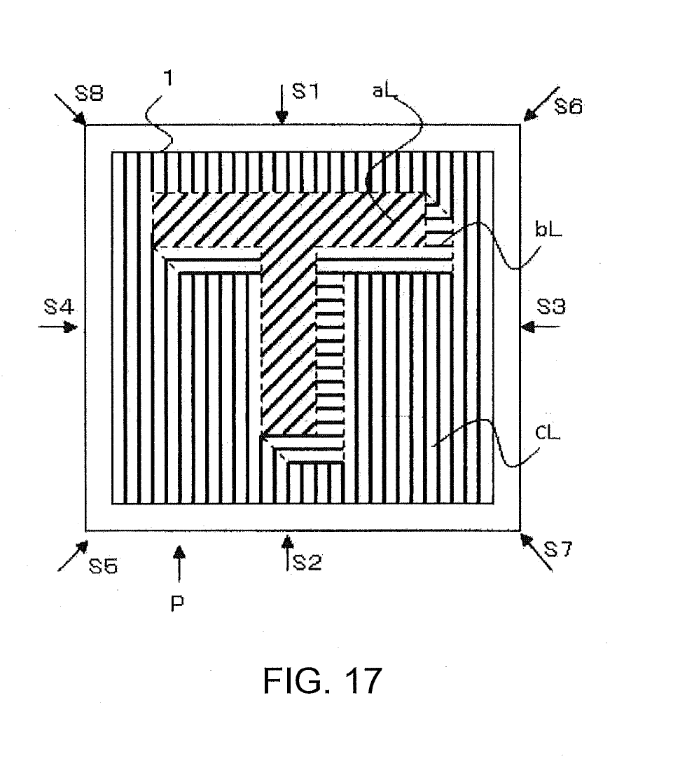

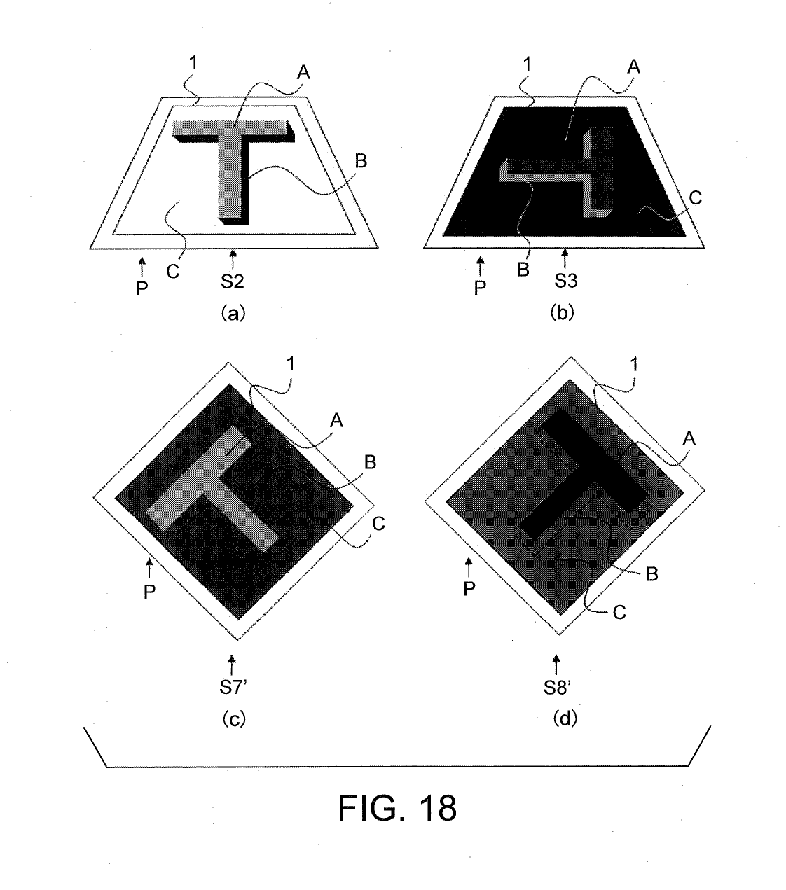

Example 5 is an example in which the second plane B is provided on the lower right side of the first plane A, as shown in FIG. 6(b). Note that since Example 5 is a modification of Example 1, a description of the same parts will be omitted, and only different parts will be explained. For example, as shown in FIG. 17, the second plane B is provided adjacently on the lower right side of the first plane A. As shown in FIG. 18, in a visually recognized state from a predetermined observation direction, the latent image and/or the shade image having a different visual density can visually be recognized from all observation directions, although the position of the shade image with respect to the latent image changes, as is apparent from comparison with FIG. 12, and advanced authenticity determination could be performed.

### Example 6

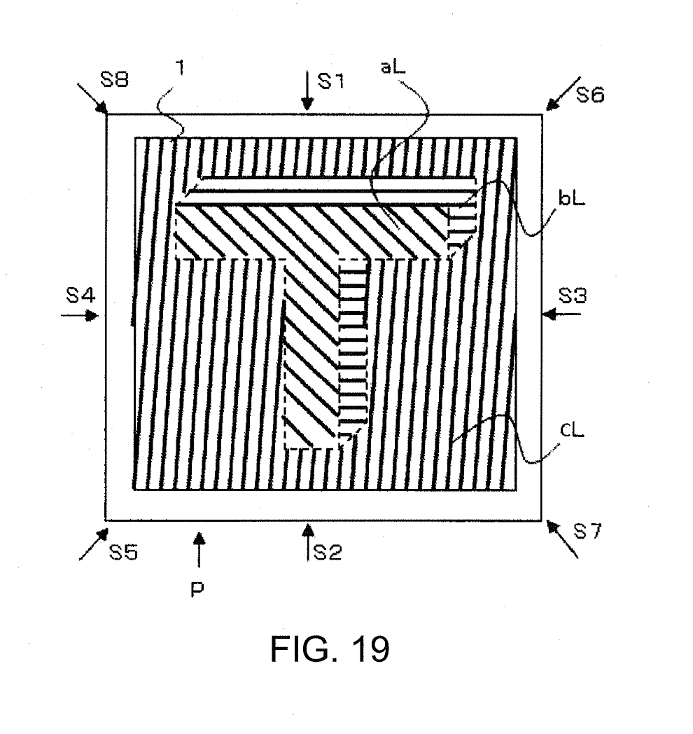

Example 6 is a modification of Example 2 in which the angle of one type of image lines in Example 2 is set within the range of 90° to 180°. More specifically, as shown in FIG. 19, the image line angle of the image lines aL was set to 135°. Note that when visually recognized from a predetermined observation direction, the same effect as in FIG. 12 was obtained, and advanced authenticity determination could be performed. Note that when the latent image intaglio 1 of each example is observed from immediately above, the latent image and the shade image cannot visually be recognized.

### Example 7

An example of the printed matter P including the latent image intaglio 1 according to the second embodiment will be described next. The printed matter P of Example 7 has an arrangement in which the gradation effect of the latent image is high in the main observation direction. As the arrangement of the latent image intaglio 1, the latent image intaglio 1 was formed by intaglio printing on the printed matter P as shown in FIG. 8. In the printed matter of Example 7, a white paper sheet was used as the base, and the intaglio image lines were formed by black ink. The latent image intaglio 1 included the latent image portion A and the background portion C, as shown in FIGS. 8 and 9. The latent image portion A was divided into four regions, that is, the first region 1A, the second region 2A, the third region 3A, and the fourth region 4A. The latent image portion A was divided in the horizontal direction.

For example, the image line width 1aW of the image lines 1aL, the image line width 2aW of the image lines 2aL, the image line width 3aW of the image lines 3aL, the image line width 4aW of the image lines 4aL, and the image line width cW of the image lines cL were set to 0.15 mm. The image line pitch 1aP of the image lines 1aL, the image line pitch 2aP of the image lines 2aL, the image line pitch 3aP of the image lines 3aL, the image line pitch 4aP of the image lines 4aL, and the image line pitch cP of the image lines cL were set to 0.25 mm. The image line height of the image lines 1aL, 2aL, 3aL, 4aL, and cL was set to 0.03 mm. As for the image line angles in the respective regions, the image lines 1aL were set to 0°, the image lines 2aL were set to 22.5°, the image lines 3aL were set to 45°, the image lines 4aL were set to 67.5°, and the image lines cL in the background portion C were set to 90°, as in level 1 of Table 1 described above.

When the latent image intaglio 1 having such an arrangement is made, and the latent image intaglio 1 shown in FIG. 8 is visually recognized from the observation direction U, that is, from immediately above, the latent image cannot visually be recognized. On the other hand, when the latent image intaglio 1 shown in FIG. 8 is visually recognized from a predetermined observation direction, the regions have visual densities as in level 1 of Table 4 described above.

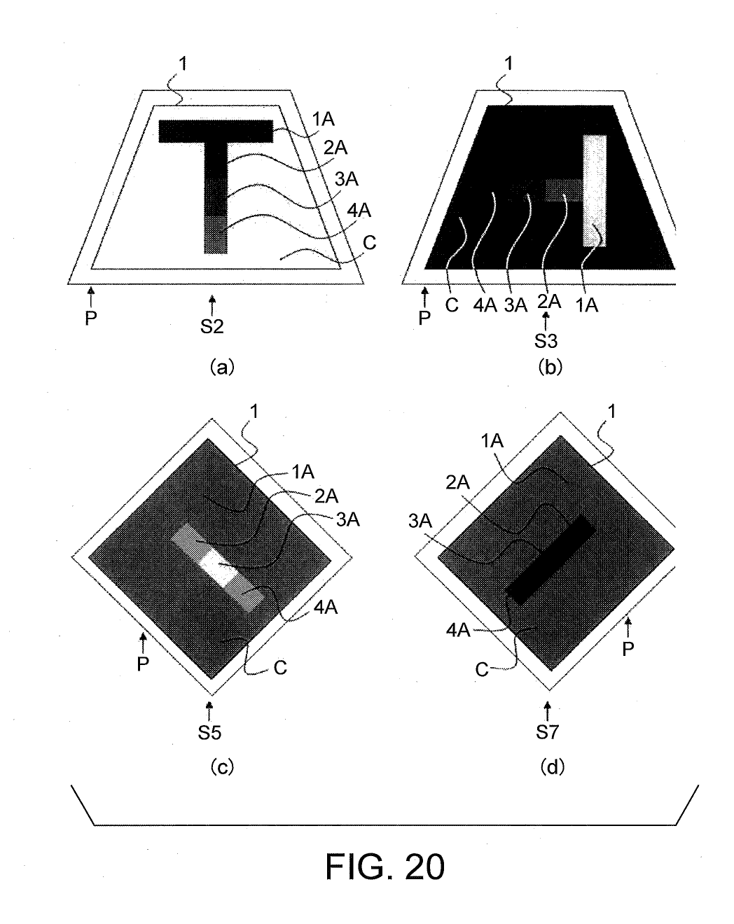

FIG. 20 shows schematic views of latent images observed when the latent image intaglio 1 of Example 7 is visually recognized from predetermined observation directions. FIG. 20(a) is a view showing a latent image observed when visually recognized from a first observation direction (S2). The visual densities in the latent image are 0% in the first region 1A of the latent image intaglio 1, 22.5% in the second region 2A, 45% in the third region 3A, and 67.5% in the fourth region 4A. A latent image having a high gradation effect can visually be recognized. On the other hand, since the background portion C is observed with a visual density of 90%, a background image having a visual density different from those in the latent image portion A can visually be recognized.

FIG. 20(b) is a view showing a latent image observed when visually recognized from a second observation direction (S3). The visual densities in the latent image are 90% in the first region 1A, 67.5% in the second region 2A, 45% in the third region 3A, and 22.5% in the fourth region 4A. A latent image having a high gradation effect can visually be recognized. On the other hand, the background portion C is visually recognized as a background image having a visual density of 0%.

FIG. 20(c) is a view showing a latent image observed when visually recognized from a third observation direction (S5). The visual densities in the latent image are 45% in the first region 1A, 67.5% in the second region 2A, 90% in the third region 3A, and 67.5% in the fourth region 4A. On the other hand, in the background portion C, a background image having a visual density of 45% can visually be recognized. Hence, the first region 1A and the background region C are visually recognized with the same visual density, but an image having a gradation formed from the second region 2A, the third region 3A, and the fourth region 4A can visually be recognized.

FIG. 20(d) is a view showing a latent image observed when visually recognized from a fourth observation direction (S7). The visual densities in the latent image are 45% in the first region 1A, 22.5% in the second region 2A, 0% in the third region 3A, and 22.5% in the fourth region 4A. On the other hand, in the background portion C, a background image having a visual density of 45% can visually be recognized. Hence, the first region 1A and the background region C are visually recognized with the same visual density, but an image having a gradation formed from the second region 2A, the third region 3A, and the fourth region 4A can visually be recognized.

As a result, when observed from the first observation direction (S2) and the second observation direction (S3), a latent image having a high gradation effect can visually be recognized with depth, and the visibility of the latent image improves. Since the first observation direction (S2) includes the main observation direction, a more effective arrangement can be obtained. On the other hand, in the third observation direction (S5) and the fourth observation direction (S7), a latent image partially having a gradation is visually recognized. Hence, the gradation of the latent image changes between the first observation direction, the second observation direction, the third observation direction, and the fourth observation direction, advanced authenticity determination can be performed. Note that each of FIGS. 20(a) to 20(d) illustrates one of predetermined observation directions. Even from the other observation direction (for example, S1 with respect to S2), a latent image having the same gradation can visually be recognized, although the orientation of the image is inverted. In addition, no latent image is visually recognized in a visible image obtained when the latent image intaglio 1 of each example is observed from the observation direction U, that is, from immediately above.

### Example 8

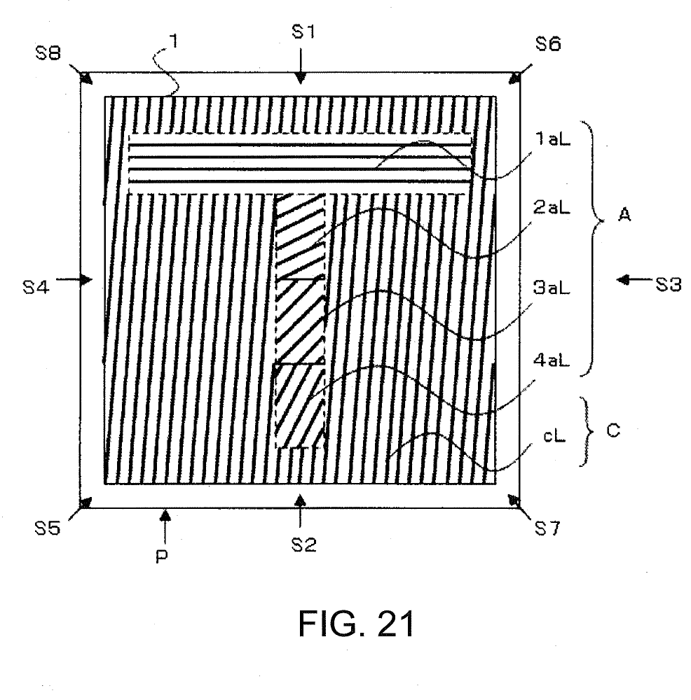

Example 8 is an example in which the wiping direction in intaglio printing is taken into consideration. Note that since Example 8 is a modification of Example 7, a description of the same parts will be omitted, and only different parts will be explained. Generally, in intaglio printing, since intaglio ink for intaglio image lines on an intaglio printing plate is wiped by a wiping roller, image lines conforming to the wiping direction (same direction) are known to have low image line reproducibility. For example, if the image line direction of the image lines cL in the background portion C of Example 7 shown in FIG. 8 is the same as the wiping direction, the image line reproducibility of the image lines cL may be undesirable. To prevent this, in Example 8, as shown in FIG. 21, the image line angle of the image lines cL was set to 75° to prevent it from conforming to the wiping direction, thereby improving the image line reproducibility of intaglio printing. Note that in a visually recognized state from a predetermined observation direction, the same effect as in FIG. 20 was obtained because no remarkable density difference existed between an image line angle of 75° and an image line angle of 90° when visually recognized from a predetermined observation direction, as shown in FIG. 1, and advanced authenticity determination could be performed.

Note that when the wiping direction is taken into consideration, the image line angle of the image lines cL is preferably set to 70° to 89°. This is because within the image line angle range of 70° to 89°, no large difference exists in the visual density when visually recognized from a predetermined observation direction, as shown in FIG. 1. For this reason, the image lines 1aL, 2aL, 3aL, and 4aL are appropriately adjusted in accordance with the image line angle of the image lines cL. The image line angle differences between the image lines 1aL, 2aL, 3aL, and 4aL are preferably equal. For example, when the image lines cL are set to 75°, the image lines 1aL are set to 0°, the image lines 2aL are set to 18.75°, the image lines 3aL are set to 37.5°, and the image lines 4aL are set to 56.25°. This makes it possible to reproduce a remarkable gradation.

### Example 9

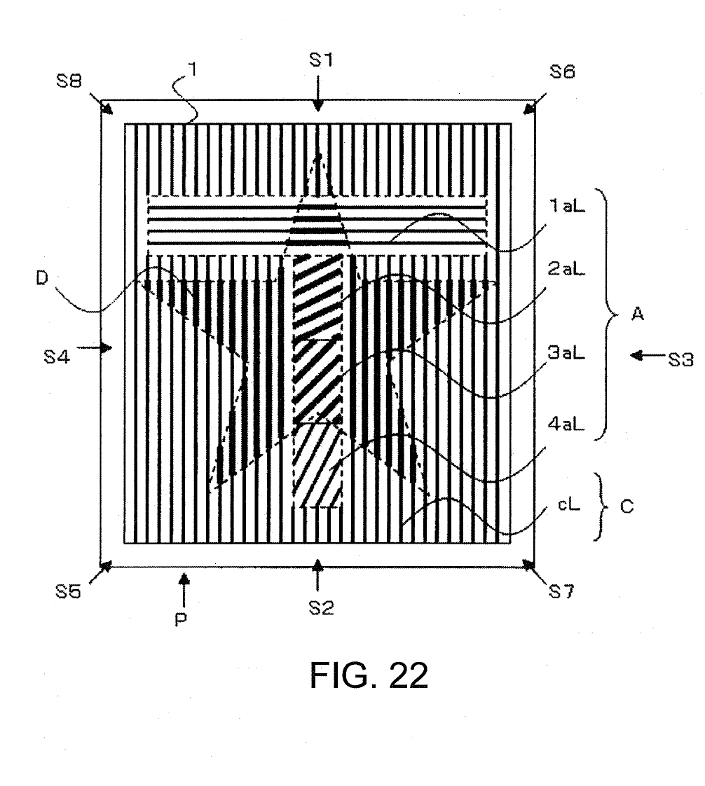

Example 9 is an example in which the camouflage properties of the latent image portion A when the printed matter P having the latent image intaglio 1 is observed from the observation direction U, that is, from immediately above are improved. Note that since Example 9 is a modification of Example 7, a description of the same parts will be omitted, and only different parts will be explained. As shown in FIG. 22, the camouflage portion D was provided in the latent image portion A and the background portion C in addition to the arrangement of Example 7, and the image line width was set to 0.18 mm only in the camouflage portion D. With this arrangement, when the latent image intaglio 1 was observed from immediately above, a camouflage image “star” could visually be recognized, and the camouflage properties of the latent image portion A were improved. Note that in a visually recognized state from a predetermined observation direction, the same effect as in FIG. 20 was obtained, and advanced authenticity determination could be performed. Note that preferably, image line width in camouflage portion D: image line width in latent image portion A and background portion C=1:±1.1 to ±1.4.

### Example 10

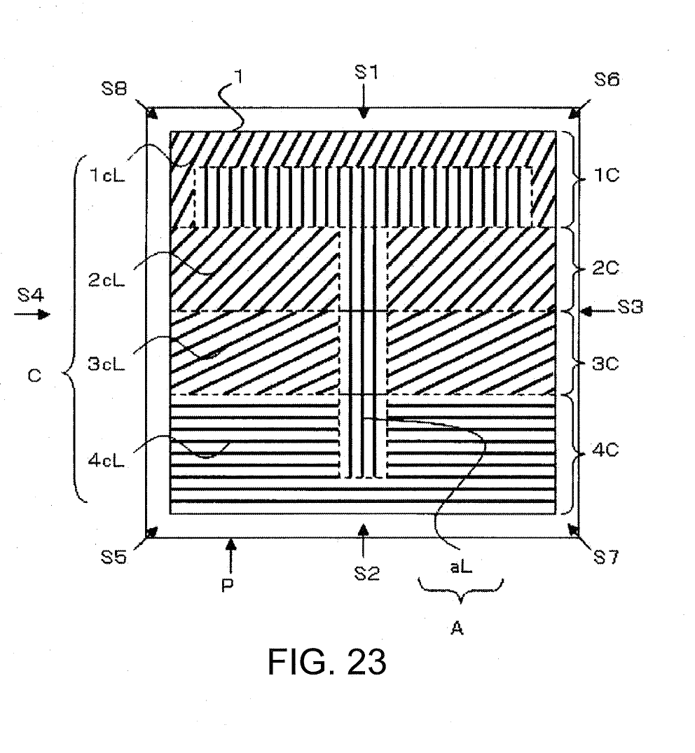

Example 10 is an example in which the arrangement of the latent image portion A and that of the background portion C of Example 7 are replaced. Note that since Example 10 is a modification of Example 7, a description of the same parts will be omitted, and only different parts will be explained. In Example 10, although the latent image portion A has a predetermined image line angle, the background portion C is divided into a first region 1C, a second region 2C, a third region 3C, and a fourth region 4C, and image lines are arranged at different angles in these regions. More specifically, as for image line angles in the regions, image lines 1cL in the first region 1C of the background portion C are set to 67.5°, image lines 2cL in the second region 2C are set to 45°, image lines 3cL in the third region 3C are set to 22.5°, image lines 4cL in the fourth region 4C are set to 0°, and the image lines aL in the latent image portion A are set to 90°, as shown in FIG. 23. A state in which the printed matter P is visually recognized from a predetermined observation direction is not illustrated. In FIG. 20, the latent image can visually be recognized with a gradation. In Example 10, however, the background image is visually recognized as an image having a gradation. For this reason, a background image having a high gradation effect could visually be recognized, and advanced authenticity determination could be performed.

### Example 11

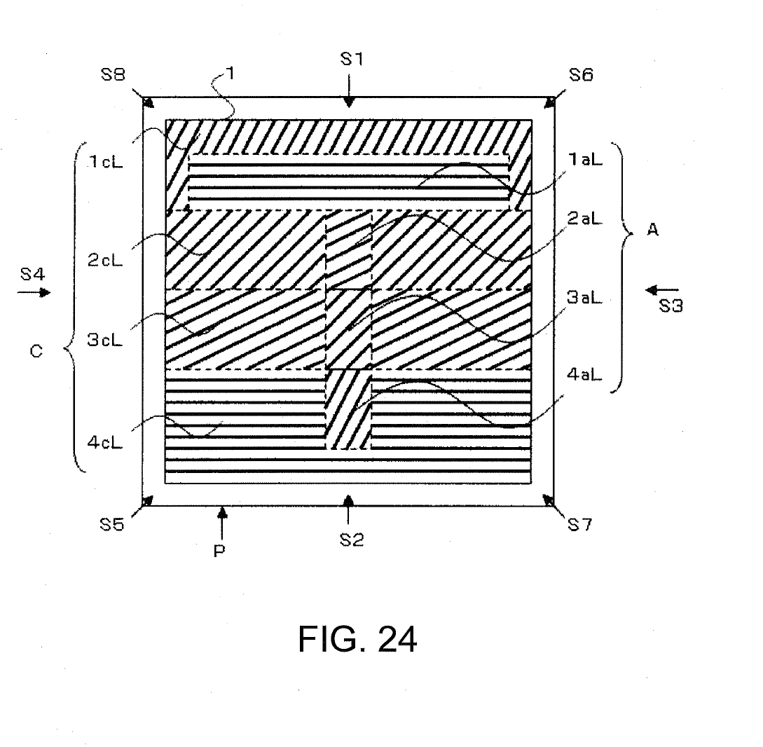

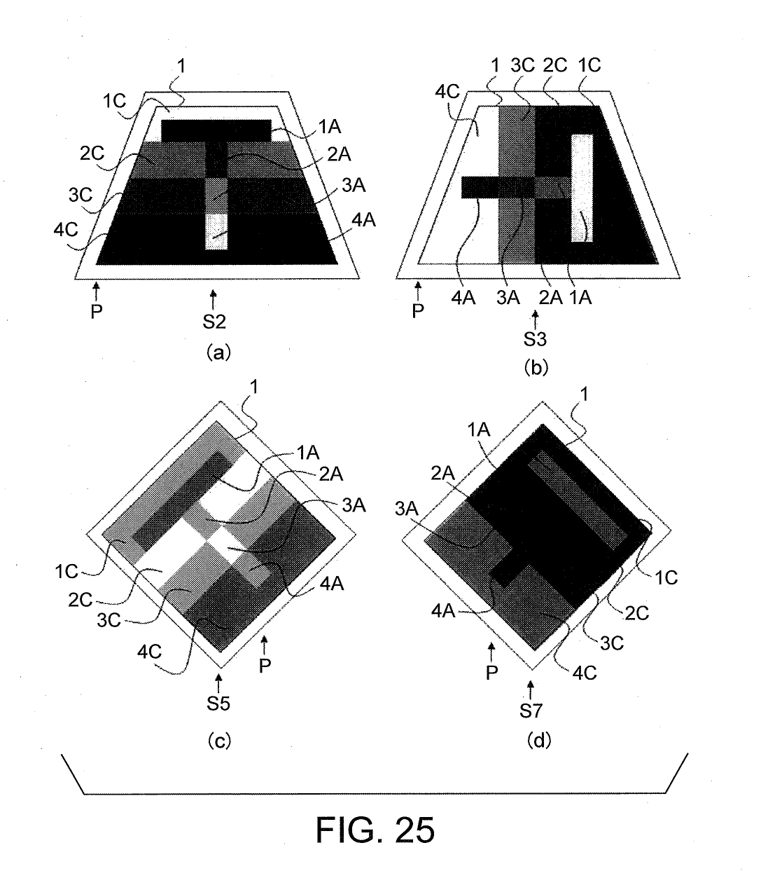

Example 11 is an example in which the arrangement of the latent image portion A of Example 7 and that of the background portion C of Example 10 are combined, as shown in FIG. 24. FIG. 25 shows schematic views of latent images observed when the latent image intaglio 1 of Example 11 is visually recognized from predetermined observation directions. FIG. 25(a) is a view showing a latent image observed when visually recognized from a first observation direction (S2). FIG. 25(b) is a view showing a latent image observed when visually recognized from a second observation direction (S3). FIG. 25(c) is a view showing a latent image observed when visually recognized from a third observation direction (S5). FIG. 25(d) is a view showing a latent image observed when visually recognized from a fourth observation direction (S7). The two gradations of the latent image and the background image are visually recognized with visual densities in opposite directions. For this reason, the visibility of the latent image further improved, and more advanced authenticity determination could be performed. Note that the number of divisions of the plurality of divided regions of the latent image portion A and the background portion C, or the latent image portion A or the background portion C can be an arbitrary number of 2 or more, but is preferably 3 or more.

### Example 12

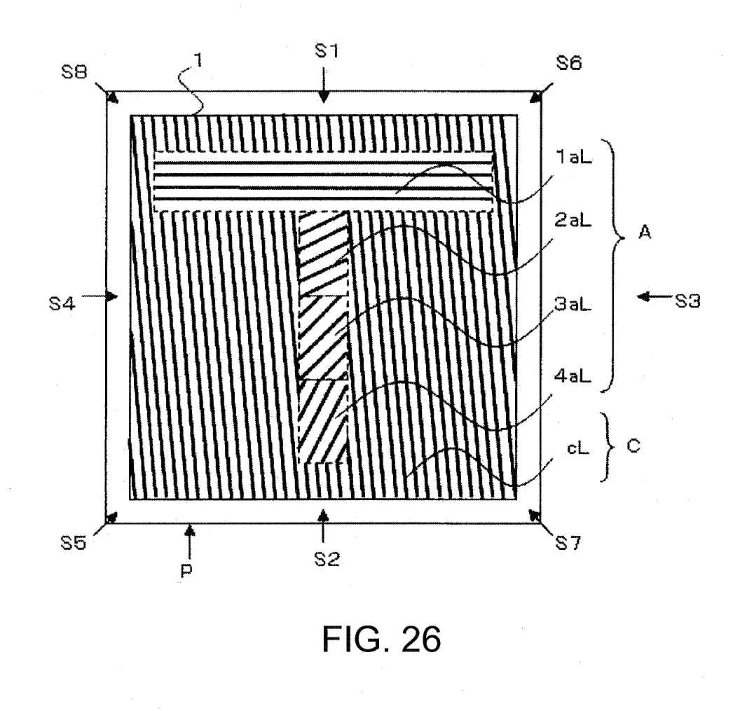

Example 12 is a modification of Example 8 in which the angle of one type of image lines in Example 8 is set within the range of 90° to 180°. More specifically, as shown in FIG. 26, the image line angle of the image lines cL was set to 105°. Note that when visually recognized from a predetermined observation direction, the same effect as in FIG. 20 was obtained, and advanced authenticity determination could be performed.

### Example 13

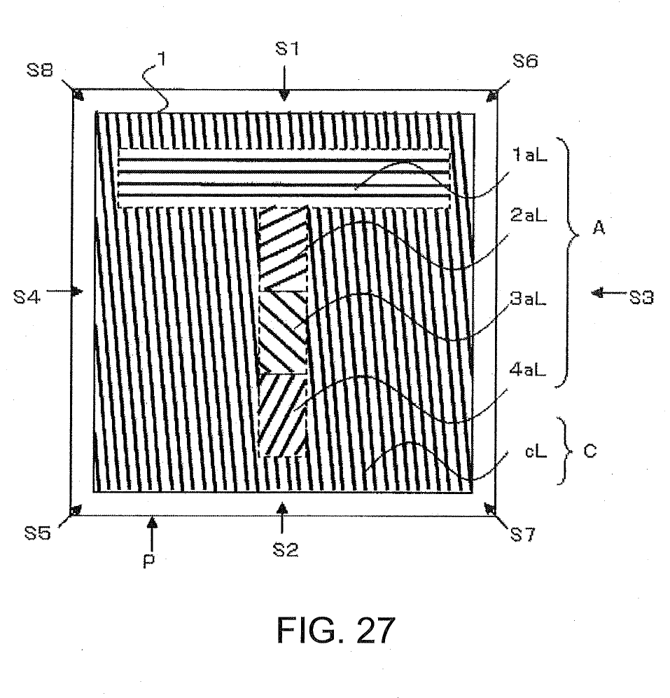

Example 13 is a modification of Example 8 in which the angles of two types of image lines in Example 8 are set within the range of 90° to 180°. More specifically, as shown in FIG. 27, the image line angle of the image lines cL was set to 105°, and the image line angle of the image lines 3aL was set to 135°. Note that when visually recognized from a predetermined observation direction, the same effect as in FIG. 20 was obtained, and advanced authenticity determination could be performed.

### Example 14

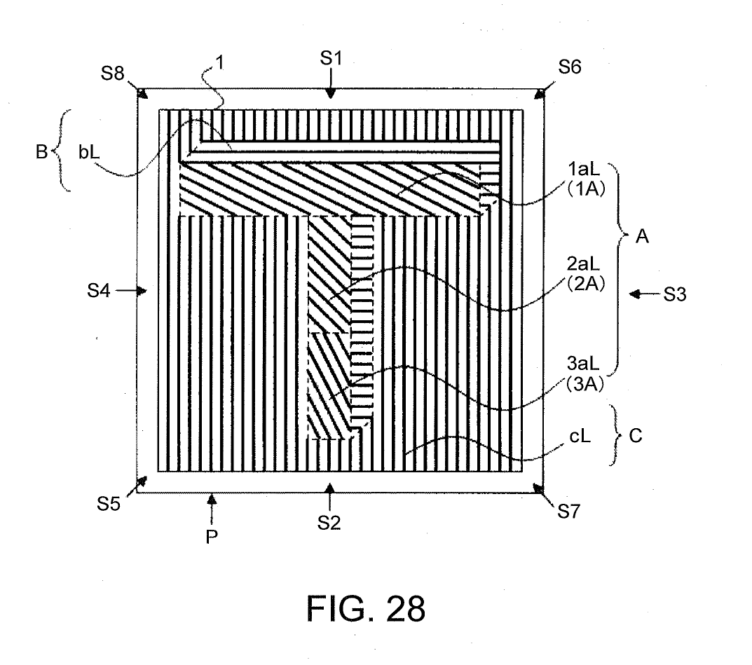

Example 14 is a modification in which an arrangement including the first plane (latent image) A, the second plane (shade image) B, and the background portion C formed in the first embodiment is provided, the first plane A is divided into a plurality of regions, and the image line angles in the divided regions are set within the range of 90° to 180°, thereby forming a gradation. FIG. 28 shows the printed matter P of Example 14. The image line arrangement includes the first plane A, the second plane B, and the background portion C. As for the image line angles in the respective regions, the image lines 1aL in the first region 1A of the first plane A are set to 157.5°, the image lines 2aL in the second region 2A are set to 135°, the image lines 3aL in the third region 3A are set to 112.5°, the image lines bL in the second plane B are set to 0°, and the image lines cL in the background portion C are set to 90°.

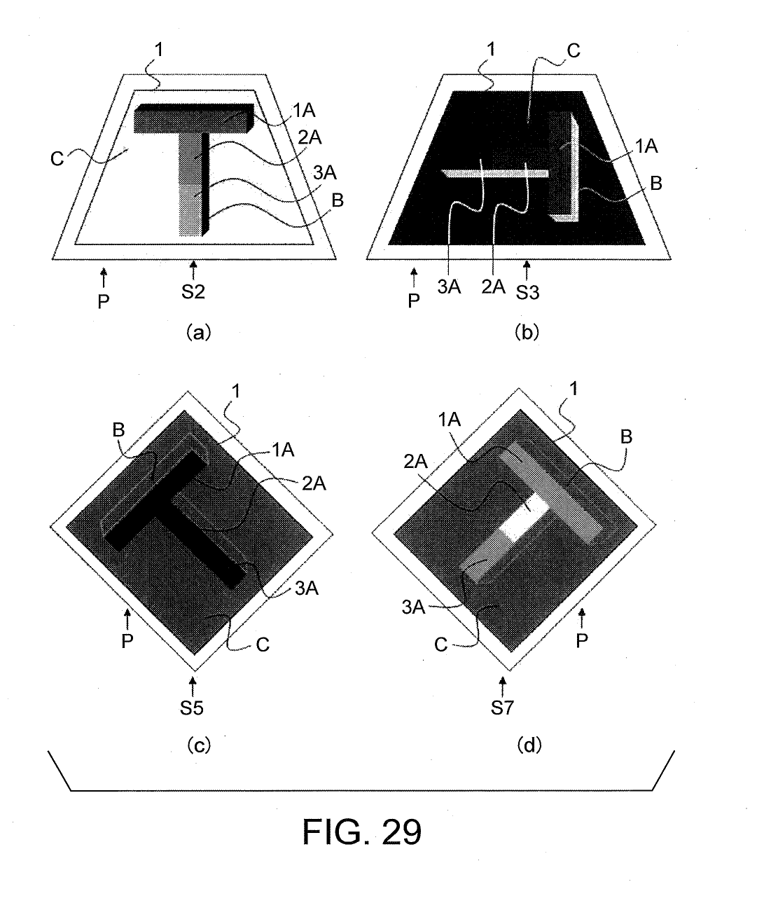

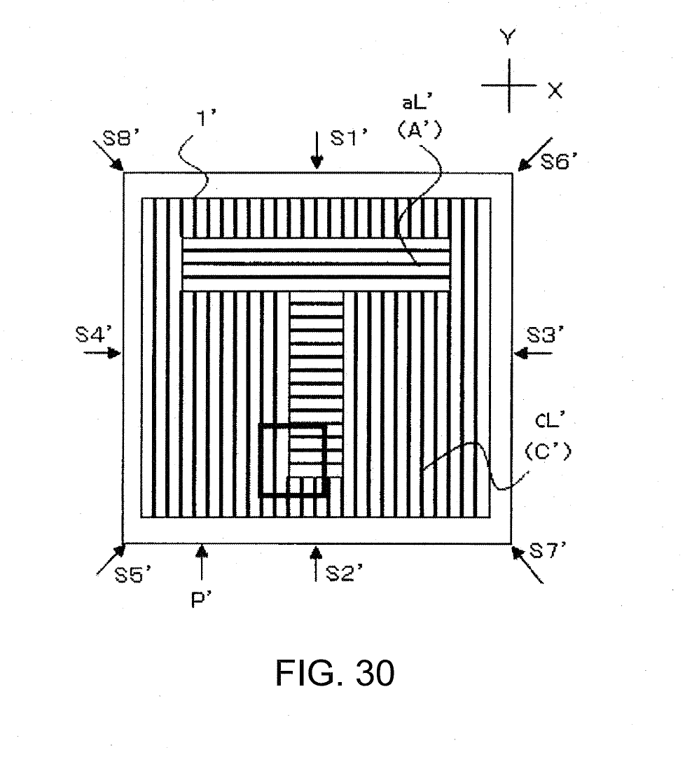

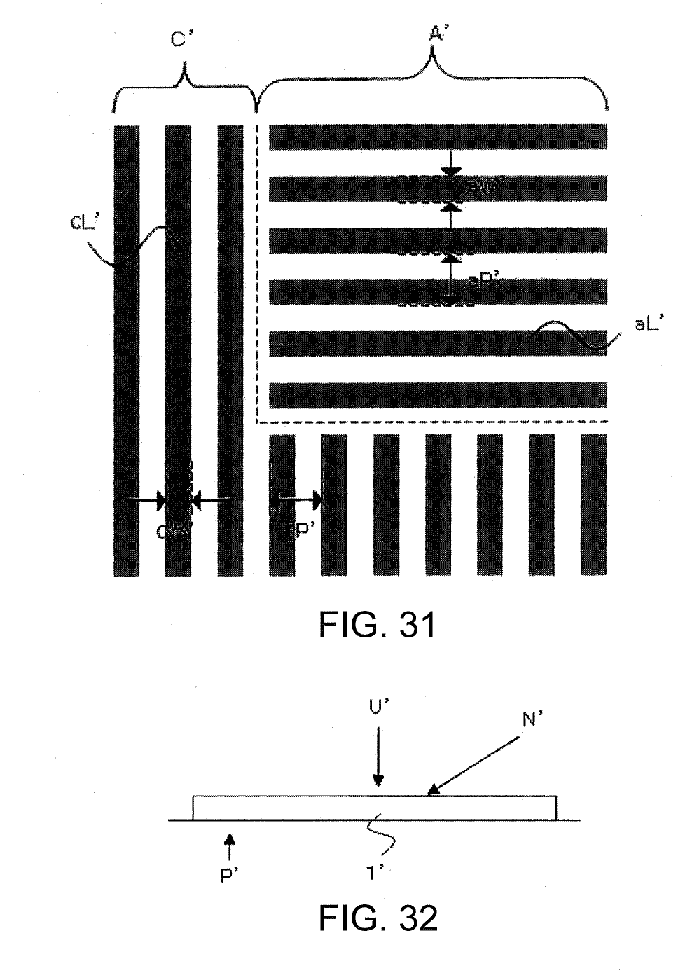

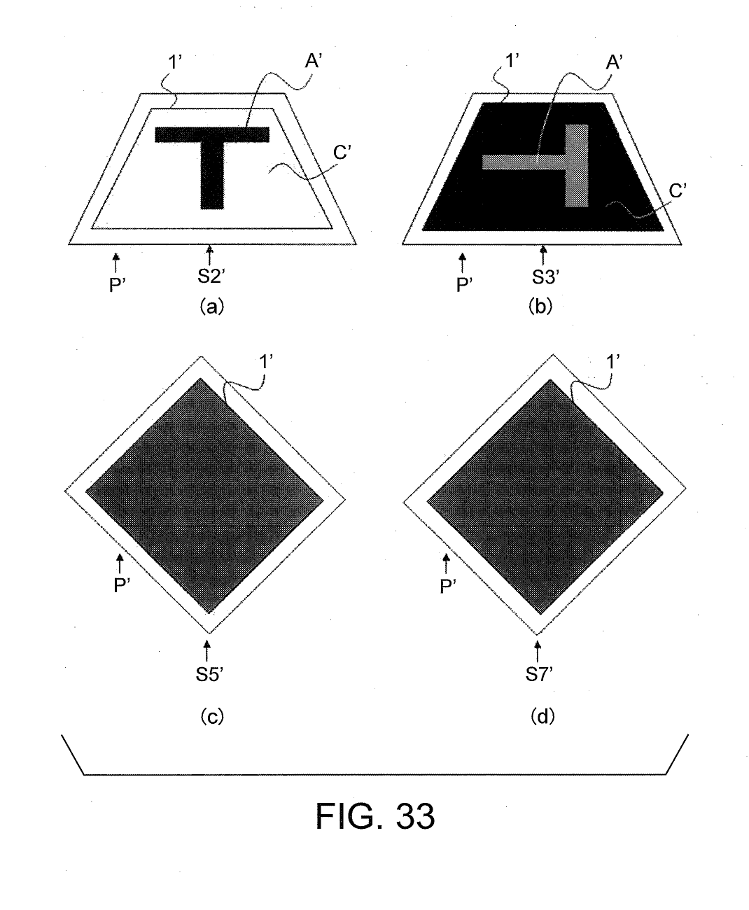

FIG. 29 shows schematic views of latent images observed when the latent image intaglio 1 of Example 14 is visually recognized from predetermined observation directions. FIG. 29(a) shows a latent image visually recognized from a first observation direction (S2), and FIG. 29(b) shows a latent image visually recognized from a second observation direction (S3). In both cases, since the gradation formed in the first plane A and the second plane B have different visual densities, the three-dimensional latent image could be more conspicuously visually recognized. On the other hand, FIG. 29(c) shows a latent image visually recognized from a third observation direction (S5), and FIG. 29(d) shows a latent image visually recognized from a fourth observation direction (S7). The second plane B and the background portion C have the same visual density and are therefore visually recognized as the same image. However, due to a gradation formed in the first plane A, a three-dimensional latent image could visually be recognized. For this reason, the visibility of the latent image improved, and more advanced authenticity determination could be performed.

As described above, in the arrangement of the latent image intaglio of the present invention, the image line angle is changed between the respective regions, thereby proposing many forms of the latent image intaglio. Accordingly, the visual densities of the latent image and the background image also change when visually recognized from a predetermined observation direction, and advanced authenticity determination can be performed. In addition, as compared to a conventional latent image intaglio, the latent image and/or the background image can visually be recognized as an image having a gradation. Furthermore, when the second plane B (shade image) is formed, the outline of the latent image is enhanced, and a three-dimensional latent image can be observed. Additionally, since the line area ratios per unit area of image lines do not change, the latent image pattern does not darken, and the degree of freedom in design is high.

### DESCRIPTION OF THE REFERENCE NUMERALS

1, 1′ latent image intaglio
P, P′ printed matter
A, A′ latent image portion, first plane
B shade portion, second plane
C, C′ background portion
D camouflage portion
U, U′ observation direction from immediately above
N, N′ observation direction from obliquely above
S1, S2, S1′, S2′ observation direction along Y axis from obliquely above with respect to printed matter
S3, S4, S3′, S4′ observation direction along X axis from obliquely above with respect to printed matter
S5, S6, S5′, S6′ observation direction along diagonal direction from obliquely above with respect to printed matter
S7, S8, S7′, S8′ observation direction along diagonal direction from obliquely above with respect to printed matter
aL, 1aL, 2aL, 3aL, 4aL, aL′ image line of latent image portion or first plane
bL, 1bL, 2bL, 3bL image line of second plane
cL, 1cL, 2cL, 3cL, 4cL, cL′ image line of background portion
aW, 1aW, 2aW, 3aW, 4aW, aW′ image line width of latent image portion or first plane
bW image line width of second plane
cW image line width of background portion
aP, 1aP, 2aP, 3aP, 4aP, aP′ image line pitch of latent image portion or second plane
bP image line pitch of second plane
cP, cP′ image line pitch of background portion
L image line
LW image line width
LP image line pitch
NL non-image line
NLW image line width of non-image line portion
θ1, θ2 angle
1A, 1B, 1C first region
2A, 2B, 2C second region
3A, 3B, 3C third region
4A, 4C fourth region

1. An anti-counterfeit printed matter in which a latent image portion including a first plane and a second plane, which are adjacent to each other, and a background portion are formed on a base, raised image lines being arranged at an equal pitch and an equal image line width in the latent image portion and the background portion, wherein
the first plane has a region in which the image lines are arrayed along a first direction,
the second plane has a region in which the image lines are arrayed along a second direction different from the first direction,
the background portion has a region in which the image lines are arrayed along a third direction different from the first direction and the second direction,
when the printed matter is observed from immediately above, the first plane, the second plane, and the background portion are observed as a visible image having a uniform image line density, and
when the printed matter is observed while being tilted by a predetermined angle, the first plane, the second plane, and the background portion attain different visual densities, and the latent image portion is three-dimensionally observed.

2. An anti-counterfeit printed matter according to claim 1, wherein the first direction, the second direction, and the third direction are different from each other by not less than 20°.

3. An anti-counterfeit printed matter according to claim 1, wherein when one direction selected from the first direction, the second direction, and the third direction is set to 0°, one of the remaining directions is set to 35° to 45°, and the other direction is set to 70° to 90°.

4. An anti-counterfeit printed matter according to claim 1, wherein at least one of the first plane, the second plane, and the background portion is divided into a plurality of regions, and the image lines formed in the plurality of regions are arranged at different angles.

5. An anti-counterfeit printed matter including, on a base, a latent image portion and a background portion in which raised image lines are arranged at an equal pitch and an equal image line width, the image lines formed in the latent image portion and the background portion being arrayed in different directions so as to form a latent image, wherein
the latent image portion and/or the background portion is divided into a plurality of regions,
when only the latent image portion is divided, the image lines are arrayed in different directions in the respective divided regions,
when only the background portion is divided, the image lines are arrayed in different directions in the respective divided regions,
when both the latent image portion and the background portion are divided, the image lines are arrayed in different directions in the respective divided regions,
when the printed matter is observed from immediately above, the latent image portion and the background portion are observed as a visible image having a uniform image line density, and
when the printed matter is observed while being tilted by a predetermined angle, the latent image portion and/or the background portion is observed while having different densities in the divided regions of the background portion.

6. An anti-counterfeit printed matter according to claim 5, wherein the plurality of divided regions of the latent image portion and/or the background portion comprise at least three regions.

7. An anti-counterfeit printed matter according to claim 5, wherein an angle of the direction of the image lines formed in the divided regions of the latent image portion and/or the background portion sequentially changes by an equal angle.

8. An anti-counterfeit printed matter according to claim 5, wherein the angles of the direction of the image lines formed in the latent image portion and the background portion are different from each other by not less than 20°.

9. An anti-counterfeit printed matter according to claim 5, wherein the direction of the image lines arrayed in at least one of the plurality of divided regions of the latent image portion and the direction of the image lines arrayed in at least one of the plurality of divided regions of the background portion have a relative angle difference of not less than 50°.

10. An anti-counterfeit printed matter according to claim 5, wherein
the angle of the direction of the image lines formed in each of the plurality of regions of the latent image portion is not more than 45°, and
the angle of the direction of the image lines formed in each of the plurality of regions of the background portion is not more than 45°.

11. An anti-counterfeit printed matter according to claim 1, wherein a camouflage image is formed by arranging the image lines while changing an area ratio per unit length of at least some of the image lines formed in the latent image portion and/or the background portion.

12. An anti-counterfeit printed matter according to claim 1, wherein an image line width of the image lines is set to 0.05 to 0.3 mm.

13. An anti-counterfeit printed matter according to claim 1, wherein an image line pitch of the image lines is set to 0.1 to 0.6 mm.

14. An anti-counterfeit printed matter according to claim 1, wherein an image line height of the image lines is set to 0.02 to 0.10 mm.

15. An anti-counterfeit printed matter according to claim 1, wherein the base has a whitish color, and the image lines are formed by blackish ink.

16. An anti-counterfeit printed matter according to claim 2, wherein when one direction selected from the first direction, the second direction, and the third direction is set to 0°, one of the remaining directions is set to 35° to 45°, and the other direction is set to 70° to 90°.

17. An anti-counterfeit printed matter according to claim 2, wherein at least one of the first plane, the second plane, and the background portion is divided into a plurality of regions, and the image lines formed in the plurality of regions are arranged at different angles.

18. An anti-counterfeit printed matter according to claim 3, wherein at least one of the first plane, the second plane, and the background portion is divided into a plurality of regions, and the image lines formed in the plurality of regions are arranged at different angles.

19. An anti-counterfeit printed matter according to claim 6, wherein an angle of the direction of the image lines formed in the divided regions of the latent image portion and/or the background portion sequentially changes by an equal angle.

20. An anti-counterfeit printed matter according to claim 6, wherein the angles of the direction of the image lines formed in the latent image portion and the background portion are different from each other by not less than 20°.
